(19) United States
(12) Patent Application Publication
(10) Pub. No.: US 2023/0110456 A1
(43) Pub. Date: Apr. 13, 2023

(54) MULTI-PLANE CONNECTOR BRACKET

(71) Applicant: Dennis LeBlang, Palm Desert, CA (US)

(72) Inventor: Dennis LeBlang, Palm Desert, CA (US)

(21) Appl. No.: 16/406,289

(22) Filed: May 8, 2019

Related U.S. Application Data
(63) Continuation-in-part of application No. 16/396,624, filed on Apr. 26, 2019, now abandoned.
Application No. 16/396,624 is a continuation-in-part of application No. 16/354,081, filed on Mar. 14, 2019, now abandoned.
Application No. 16/354,081 is a continuation-in-part of application No. 16/198,831, filed on Nov. 22, 2018, now abandoned.
Application No. 16/198,831 is a continuation-in-part of application No. 16/195,847, filed on Nov. 19, 2018.
Application No. 16/195,847 is a continuation-in-part of application No. 15/724,137, filed on Oct. 3, 2017, now Pat. No. 10,422,136.
Application No. 15/724,137 is a continuation-in-part of application No. 15/449,250, filed on Mar. 3, 2017, now Pat. No. 10,683,665.
Application No. 15/449,250 is a continuation-in-part of application No. 15/430,781, filed on Feb. 13, 2017.
Application No. 15/430,781 is a continuation-in-part of application No. 15/295,172, filed on Oct. 17, 2016, now Pat. No. 10,364,566.
Application No. 15/295,172 is a continuation-in-part of application No. 15/090,460, filed on Apr. 4, 2016, now Pat. No. 11,060,281.
Application No. 15/090,460 is a continuation-in-part of application No. 14/946,378, filed on Nov. 19, 2015, now Pat. No. 11,391,038.
Application No. 14/946,378 is a continuation-in-part of application No. 13/398,243, filed on Feb. 16, 2012, now abandoned.
Application No. 13/398,243 is a continuation-in-part of application No. 12/456,707, filed on Jun. 22, 2009, now Pat. No. 8,161,699.
Application No. 12/456,707 is a continuation-in-part of application No. 12/231,875, filed on Sep. 8, 2008, now Pat. No. 8,176,696.
(60) Provisional application No. 62/533,092, filed on Jul. 16, 2017.
(60) Provisional application No. 62/490,917, filed on Apr. 27, 2017.
(60) Provisional application No. 62/485,114, filed on Apr. 13, 2017.
(60) Provisional application No. 62/399,434, filed on Sep. 25, 2016.
(60) Provisional application No. 62/385,932, filed on Sep. 9, 2016.
(60) Provisional application No. 62/378,615, filed on Aug. 23, 2016.
(60) Provisional application No. 62/369,041, filed on Jul. 30, 2016.
(60) Provisional application No. 62/345,153, filed on Jun. 3, 2016.
(60) Provisional application No. 62/308,520, filed on Mar. 15, 2016.
(60) Provisional application No. 62/294,756, filed on Feb. 12, 2016.
(60) Provisional application No. 62/274,134, filed on Dec. 31, 2015.
(60) Provisional application No. 62/264,033, filed on Dec. 7, 2015.
(60) Provisional application No. 62/170,269, filed on Jun. 3, 2015.
(60) Provisional application No. 62/139,916, filed on Mar. 30, 2015.
(60) Provisional application No. 62/083,276, filed on Nov. 23, 2014.
(60) Provisional application No. 61/629,552, filed on Nov. 22, 2011.
(60) Provisional application No. 61/628,044, filed on Oct. 24, 2011.

(51) Int. Cl. F16B 7/22; E04B 1/41

(52) U.S. Cl. CPC F16B 7/22; E04B 1/40; E04B 2001/405

(57) ABSTRACT

The present invention relates to a metal framing bracket secured between support members or secured to a single support member having lips with notches engaging the aperture of support members allowing additional bracing members to overlap the brackets or channel shapes by increasing or decreasing the bracket size and shape of the bracket.

This application is a continuous-in-part pending application U.S. Ser. No. 16/406,289 filed May 8, 2019 by the Inventor, the disclosure of which is incorporated to related applications claims priority to the following:
continuous-in-part pending application U.S. Ser. No. 16/396,624 filed Apr. 26, 2019 and;
continuous-in-part pending application U.S. Ser. No. 16/354,081 filed Mar. 14, 2019 and;
continuous-in-part pending application U.S. Ser. No. 16/198,831 filed Nov. 22, 2018 and;
continuous-in-part pending application U.S. Ser. No. 16/195,847 filed Nov. 19, 2018 and;
continuation-in-part pending application U.S. Ser. No. 15/724,137 filed Nov. 3, 2017 that included
provisional application U.S. 62/533,092 filed Jul. 16, 2017 (now expired) and;
provisional application U.S. 62/490,917 filed Apr. 27, 2017 (now expired) and
provisional application U.S. 62/485,114 filed Apr. 13, 2017 (now expired) and
continuous-in-part pending application U.S. Ser. No. 15/449,250 filed Mar. 3, 2017 that included
provisional application U.S. 62/399,434 filed on Sep. 25, 2016 (now expired) and;
provisional application U.S. 62/385,932 filed on Sep. 9, 2016 (now expired) and;
provisional application U.S. 62/378,615 filed on Aug. 23, 2016 (now expired) and;
provisional application U.S. 62/360,041 filed on Jul. 30, 2016 (now expired) and;
provisional application U.S. 62/345,153 filed on Jun. 3, 2016 (now expired) and;
provisional application U.S. 62/308,520 filed on Mar. 15, 2016 (now expired) and;
continuation-in-part of application U.S. Ser. No. 15/430,781 filed Feb. 13, 2017 which claims priority to the following:
provisional application U.S. 62/264,033 filed Jul. 15, 2015 (now expired) and
provisional application U.S. 62/274,134 filed Dec. 31, 2015 (now expired) and
provisional application U.S. 62/294,756 filed Feb. 12, 2016 (now expired) and
provisional application U.S. 62/298, 762 filed Feb. 23, 2016 (now expired) and
provisional application U.S. 62/308,520 filed Mar. 15, 2016 (now expired) and
provisional application U.S. 62/345,153 filed Jun. 3, 2015 (now expired) and
provisional application U.S. 62/360,041 filed on Jul. 30, 2016 (now expired) and;
provisional application U.S. 62/378,615 filed on Aug. 23, 2016 (now expired) and;
provisional application U.S. 62/385,932 filed Sep. 9, 2016 (now expired) and
provisional application U.S. 62/339,434 filed Sep. 15, 2016 (now expired) and
continuation-in-part of application U.S. Ser. No. 15/295,172 filed Nov. 17, 2016 now U.S. Pat. No. 10,364,566 issued Jul. 30, 2019, which claims priority to the following:
provisional application U.S. 62/378,615 filed on Aug. 23, 2016 (now expired) and;
provisional application U.S. 62/369,041 filed on Jul. 30, 2016 (now expired) and;
provisional application U.S. 62/345,153 filed on Jun. 3, 2016 (now expired) and;
provisional application U.S. 62/294,756 filed on Feb. 12, 2016 (now expired) and;
provisional application U.S. 62/274,134 filed on Dec. 15, 2015 (now expired) and;
provisional application U.S. 62/264,033 filed on Dec. 7, 2015 (now expired) and;
provisional application U.S. 62/244,135 filed on Nov. 20, 2015 (now expired) and;
continuation-in-part on application U.S. Ser. No. 15/090,460 filed Apr. 4, 2016 now patent U.S. Pat. No. 11,060,281 issued Jul. 7, 2021, which claims priority to the following:
provisional application U.S. 62/242,705 filed Nov. 16, 2015 (now expired) and;
provisional application U.S. 62/208,766 filed Aug. 23, 2015 (now expired) and;
provisional application U.S. 62/175,191 filed on Jun.12, 2015 (now expired), and;
provisional application U.S. 62/170,269 filed Jun. 3, 2015 (now expired) and;
provisional application U.S. 62/143,097 filed Apr. 4, 2015 (now expired) and;
continuation-in-part of pending application U.S. Ser. No. 14/946,378 filed Nov. 19, 2015, which claims priority to the following:
provisional application U.S. 62/175,191 filed on Jun. 12, 2015 (now expired), and;
provisional application U.S. 62/170,269 filed on Jun. 3, 2015 (now expired), and;
provisional application U.S. 62/139,916 filed on Mar. 30, 2015 (now expired), and;
provisional application U.S. 62/083,276 filed on Nov. 23, 2014 (now expired), and;
continuation-in-part of application U.S. Ser. No. 13/398,243 filed on Feb. 16, 2012, now abandoned, which claims priority to the following:
provisional application U.S. 61/629,552 filed on Nov. 22, 2011 (now expired), and;
provisional application U.S. 61/628,044 filed on Oct. 24, 2011 (now expired), and;
continuation-in-part of application U.S. Ser. No. 12/456,707 filed on Jun. 22, 2009 now patent U.S. Pat. No. 8,161,699 issued Apr. 24, 2012 and by the inventor hereof, the disclosure of which is incorporated to related applications. The disclosures of the above cite U.S. Patent Applications and US Provisional Application of the Applicant, including all drawing and all the specifications, are hereby incorporated to related applications by reference in their entireties in this U.S. Patent Application.

### FEDERALLY SPONSORED RESEARCH OR DEVELOPMENT

Not applicable

### PARTIES OR JOINT RESEARCH

Not applicable

### FIELD OF THE INVENTION

The present invention relates to connecting U-bracing channels to support members using connector bracing brackets having various types of bridging connectors with bridging notches that interlock to the web of the support members through the aperture hole with the bridging notches engaging the hole side edges and secured to the U-bracing channels.

### BACKGROUND OF THE INVENTION

Light gauge metal framing have been used in the construction of buildings for many years, however interior and exterior metal framing has always been difficult to assemble as well as construct horizontal and diagonal bracing between support framing members because of the configuration of the support members like a C channel and poor energy efficient shear wall construction. The lip and flange of the C channel protruding from the web makes it difficult to make connections. When bracing members are installed between support members for additional strength, insulation became even more difficult to install as well as form a better insulated wall.

The bracing members within the wall forming structure are generally required to connect support members together, however horizontal bracing members can be very long and next to impossible to connect horizontal bracing members to individual spacer blocks located between support members. Bracing clips have been used to connect the continuous bracing members to the support members and then adding extra fasteners to connect to the support members. Typically metal framing has an elongated metal bridging member typically inserted horizontally through punched opening in a series of vertical studs to keep them aligned. Steel studs have good support strength when they are straight, but a significant portion of that strength is lost if the studs are twisted. Therefore the support members have holes and channel shaped bridging is installed to reduce the mechanical torgue as metal studs can twist or bend and loose their bearing capacity. In order to reduce the twisting, blocking has been installed between wood studs and the horizontal bridging has been used for metal framing. Metal framing like wood framing are installed at standard spacing dimensions and corresponds to standard sheathing or drywall dimensions. On the other hand doors, windows and standard spacing cannot always be achieved and therefore individual horizontal bracing connections are required.

### DESCRIPTION OF PRIOR ART

It appears that one company continually is creating brackets that fit over existing channels and then connecting the bracket to the channels. Additional clips are then added to connected the brackets to the support member. Other companies use angles to connect the horizontal bracing member to connect to the support members. Angle with notches have also been used to connected bracing members to support members. The enclosed applications using various types of notches that connect to other bracing members as well as the support members.

### SUMMARY OF THE INVENTION

The present invention shows various bridging connectors used to connect spacing-bracing members and U bridging channels to support members. Typically the U-shaped channel-bridging member connects adjacent support members by engaging the side edges of the hole of the support members. The U-shaped channel-bridging member is not a firm connection so the bridging bracket connectors engage each support member by using the bridging notches to engage the hole side edges and fasteners to connect to the U-shaped channel-bridging member. Connector brackets have been used to connect adjacent support members together, however typically the connector bracket is being connected to one support member. Overlapping bridging connector brackets usually have a wider or narrower profile and may also be shorter or taller than the connecting member being attached to the bridging connector bracket. Some bridging connector brackets are shown as an end connection so only one end extends outward away from the support member. The bridging connector brackets have features in the holes of the support members like notched holes or protrusions that extend into the hole opening that retains the connector bracket to the support member from moving vertically. Bridging connector brackets can be inserted into spacing-bracing members or over the exterior profile of the spacing-bracing member and still maintain a secure connection to the support member. Bracing plates can be secured over the bridging connector brackets that interlock into the bridging connector bracket and where the bracing plates are then fastened to the support member. The shape of the bridging connector bracket can have various shapes where the shapes interlock into the hole notches or the notches within the connector brackets. The bridging connector brackets can be shaped like an angle connector where the notch is at the angle forming ½ notch in the vertical portion of the angle connector with the horizontal portion having the other ½ portion of the notch. The bridging connector brackets can have punched-out notches that retain the bridging connector brackets from moving vertically by engaging the ledge or rim that protrudes from the edge of the aperture or the edge of a support member.

### BRIEF DESCRIPTION OF THE DRAWINGS

FIG. 1 shows a reverse lip bracket having a bottom side, two vertical sides with notches at the horizontal lips engaging the hole of the support member install between the webs of a bracing member being U shaped with the web of the bracket fasten to the bracing member.

FIG. 2 is the same as FIG. 1 except the reverse lip bracket shown as a reverse lip shape with notches at the lips is installed in the hole of the support channels first and the bracing member being U shaped facing upwards is installed between the flanges of the bracket.

FIG. 3 shows vertical notches in the side edges of the hole that interlock into the horizontal notches of the lips of the reverser lip bracket plus a downward extended tab shown inserted into the tab hole of the horizontal bracing channel.

FIG. 4 shows a butterfly shape of a reverse lip bracket having notches in the lips connected to the side edges of the hole and lip of the support member.

FIG. 5 shows a reverse lip bracket having notches in the lips connected at the side edges of two adjacent support members.

FIG. 6 shows a horizontal bracing channel with its ventral side facing downward spanning over the hole of a support member with a reverse lip bracket having its ventral side inserted over the horizontal bracing channel having a vertical notch at the side edges of the hole and horizontal notches at the lips of the reverse lip bracket along with extended tabs inserted into the tab holes of the horizontal bracing channel.

FIG. 7 shows the interlocking vertical and horizontal notches and the extended tabs inserted into the tab holes.

FIG. 8 shows an isometric of a butterfly bracket connected at the side hole edges by intersecting hole notches and bracket-flange notch along with an extended tab with arm tabs that are secured at the lips of the bracing channel.

FIG. 9 is an enlargement of the butterfly bracket with the arms tabs on the extended tab of the punch out tab.

FIG. 10 is an isometric view of a U channel coupling inserted in the open channel of two horizontal reverse lip channels.

FIG. 11 is an isometric view of a U channel coupling where two horizontal reverse lip channels are inserted into the open channel of the coupling between the flanges and web of the U channel coupling.

FIG. 12 shows the C shaped spacer brace is smaller and passes through the hole 36 in a support member. The C shaped spacer brace is shown having the exterior side of the lips 303c supported on the hole bottom edge 36be with the side edges of the lip 303c extending against the notch 126n of the notched-tab 126nt. If the C shaped spacer brace 303 is required to be fixed a lip notch 126p needs to be installed so the C shaped spacer brace 303 will not be allowed to slide horizontally.

FIG. 13 is a sectional view with the exterior side of the web 302a of the U shaped spacer brace 303 is shown even with the top edge of the support member and the notched-tab 126nt has it top edge being the anchor space 355 for the interior side of the web 303a to rest on. In addition the flanges 303b extend into the web-gap 45w allowing the lips 303c to flex and become engaged into the notch 126n of the notched-tab 126nt.

FIG. 14 shows an L-shaped bracket having extended tabs are into the tab holes of the horizontal bracing channel.

FIG. 15 shows an L-shaped bracket with the vertical leg extends across the hole in the support member rather than the lips and flanges of the support member.

FIG. 16 shows the space brace being connected to an adjacent spacer brace having one end engaged at the hole with a hook tongue having a notched-tab extend into the slot hole receiver. A round receiver hole shows the opposing end having angular extension allowing the spacer brace to be angled horizontally for an undulating framing wall.

FIG. 18 is similar to FIG. 17 showing a U shaped spacer brace where the flanges extend on the outside edges of the vertical flanges of the support member, but the extensions of the longitudinal spacer braces are shorter so the notched-tabs with the receiver holes are between the vertical support members allowing the undulating wall to pivot in the receiver holes having the notched-tabs be the pivots. In FIGS. 16 & 17 the notched-tabs extending through the receiver holes, however the width of the spacer brace in FIG. 18 shows is wider than the width of the support members and the extensions at the receiver hole and the hook tongue are tapered so the notched-tabs can pivot for a curved wall.

FIG. 17 shows the spacer brace is shown as a reverse lip spacer brace having a web, two longitudinal walls with extending longitudinal lips with notches extending inward from the free edge with the lips facing upward and the web extension being a hook tongue with the notched-tab facing upward with both webs having an extension having tapered sides for the notched-tab to fit into the receiver hole forming the vertical wall can have an undulating wall configuration.

FIG. 19 shows an upward oriented U shaped reverse lip spacer brace connecting adjacent support members and overlapping an adjacent spacer brace connecting the lip notches to the support members at the holes.

FIG. 20 shows an upward oriented U shaped reverse lip spacer brace having angular flanges connecting adjacent support members and overlapping an adjacent spacer brace connecting the lip notches to the support members at the holes.

FIG. 21 shows a downward oriented U shaped reverse lip spacer brace overlapping an identical adjacent spacer brace connected at the lip notches to the holes of a support member.

FIG. 22 shows two downward adjacent oriented spacer braces having the lower oriented spacer brace with a lip-flange notch engaging the hole bottom edge with the upper oriented spacer brace having only lip notches engaging the hole side edges.

FIG. 23 shows an upward oriented U shaped spacer brace with notches at bottom and sides engaging the hole sides that overlaps an adjacent spacer brace with a notched tab extension at the web that engages the sides of the hole.

FIG. 24 shows an upward oriented U shaped spacer brace with notches at the bottom and sides engage the hole sides and an adjacent spacer brace with an upward hook engage the flat plate that is fastened to the support member.

FIG. 25 shows a downward oriented U shape spacer brace with the flanges and web being indented at the hole and the web extending over the hole bottom edge with the opposing end of an identical U shaped spacer brace having the flanges and web being indented at the hole, however the web extension has a hook tongue extending upward that overlaps the first U shaped spacer brace for connecting a bracing plate to the support member.

FIG. 26 shows downward U shaped spacer brace with notch in flanges engage hole bottom edge with an identical U shaped spacer brace having the opposing end having an indentation at flanges and web with web extension having a hook tongue overlap the web of the first U shaped spacer brace extending downward into the receiver slot hole.

FIG. 27 shows two adjacent upward oriented U shaped spacer braces connecting to a support member with the web of the longitudinal end having flange notches connected to the underside of a hole protrusion with the opposing end having a web extension with a hook tongue for insertion into a receiving hole in the web of the adjacent spacer brace along with 2 diagonal oriented U shaped spacer braces where the hook finger end connection has an extension that engages the hole top edge at the hole notch while the lower diagonal oriented U shaped spacer brace has a notch tab end connection that engages the hole side edges.

FIGS. 28-30 shows an elevation, enlargement and section of metal framing uses a U shape spacer brace with flange notches having a T-shape rather than the L-shape previously described as the aperture has ledges that can be turned to face either direction therefore the T-shape notches has more flexibility when being installed.

FIGS. 31 & 32 shows an elevation and enlargement of metal framing where the two U shape spacer braces overlap each other with the flanges extending upward away from the web and where the flange notches extending into protrusions extending from the aperture at the metal framing supports with the flange notches engaging the underside of the protrusions. FIG. 33 appear the same, however the U shape spacer brace has the flanges extending into the bottom edge of the aperture in the metal framing supports and the flange notches have an additional horizontal notch where the horizontal notch extends into the ledges of the aperture in the metal framing support. In addition, protrusions extend from the hole side edges securing the U shaped spacer braces from moving vertically.

FIGS. 34-36 shows an elevation, enlargement and section of metal framing shows a W-shape spacer brace where the end of the flanges have a notch and where the notches extend into the bottom edge of ledges protruding from the hole side edges and where the spacer braces being of different widths to overlap and fit into adjacent W-shape spacer braces. On the other hand a reverse lip spacer brace can be used as the lower spacer brace fitting into the side edges of the metal framing support side edges with the W-shape clip fitting into the bottom edge of the ledges extending from the aperture of the metal framing support.

FIGS. 37-39 shows an elevation, enlargement and section of metal framing having a combination of several spacer braces as the shape is similar to a reverse lip spacer brace having bent flanges and where the flanges and the web have an acute angle that penetrates the aperture side edges with a hole notch and where the aperture side edges and the aperture bottom edge have another notch for the lip notches to extend into while the upper reverse lip spacer brace uses only the lip notches to engage the aperture side edges and the lower spacer brace has the extended web with an upward extending tongue to engage the opposing end of the adjacent spacer brace having a hole receiver in the web for the lower tongue to fit into.

FIG. 40 shows the notch in the first piece of the two piece bracket is notched to one side of the notch engages only one side of the hole in the support member and the other side of the notch is larger as it penetrates the side edges and lip of the first piece and the flat plate of the second piece secures the opposite end of the notch.

FIG. 41 has a long first piece of a two piece bracket used having two sets of notches in the side edges, one set of notches engaging the flat plate and the other set of notches engaging the web of the U shaped second piece with both of the second pieces attached to the support member.

FIG. 42 shows a U shaped bracing member with the sides facing upwards and a U shaped bracket with its sides fitting into the U shaped bracing member and its top side having notches in the sides and top side for a flat plate to fit into the notches and fastened to the web of the support member.

FIG. 43 shows a bracing member that is V shaped pointing upwards with a notch at the vertex and the one piece bracket is a flat plate that is secured into the notch and fastened to the web of the support member.

FIGS. 44A, 44B & 44C shows the steps required in order to install six spacer braces intersecting a one hole in the support member.

FIG. 45 shows the bulge of the spacer brace insert into the hole notch at the lower corners of the hole in the support member.

FIG. 46 shows the bulge having a bulge notch where the side edge hole fits into and the lip of the space brace fits into the hole notch of the web in the support member.

FIG. 47 shows an isometric view of FIG. 325 where the bulge notch fit into the side edge of the hole and the lip from the spacer brace fits into the hole notch of the web in the support member.

FIG. 48 shows a similar isometric view of FIG. 325 however the flange and lip form obtuse angles.

FIG. 49 shows the same isometric view of the spacer brace 45 except the side-edges of the hole are inserted to the depth of the back of the notch allowing the spacer brace to be inserted into the deeper side-edges of the hole.

FIG. 50 shows an isometric view of FIG. 48.

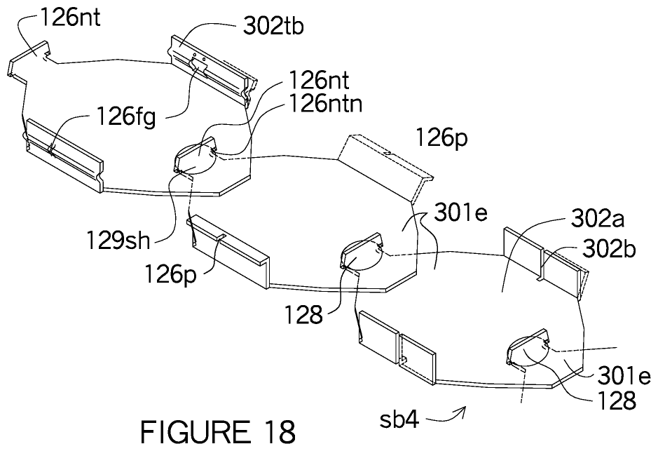

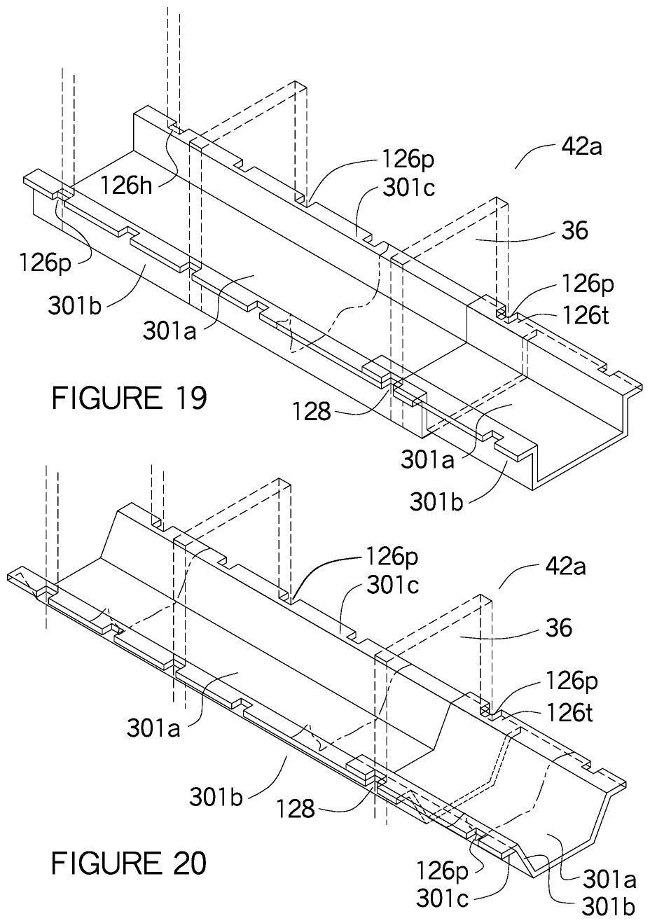

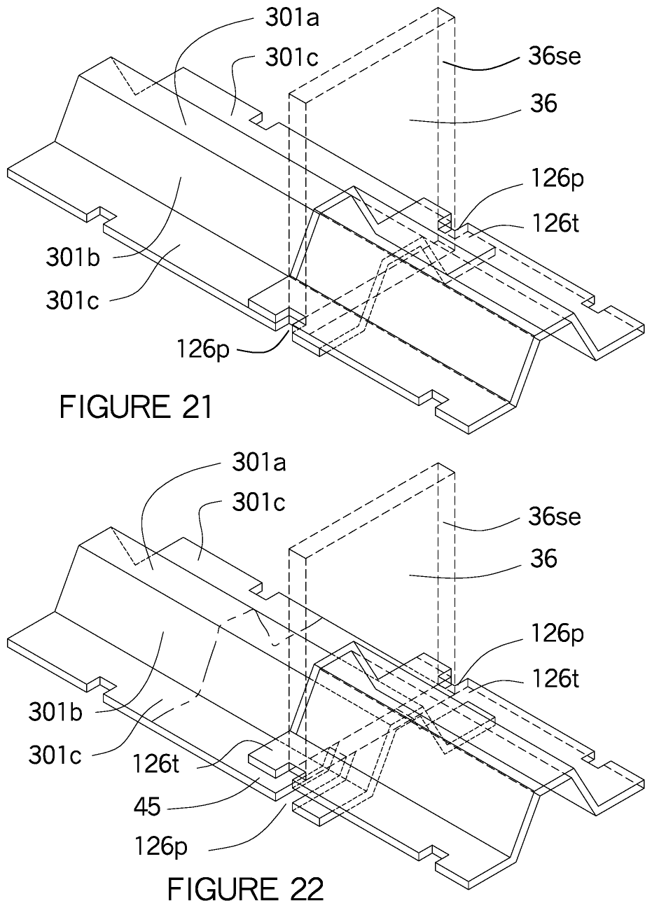

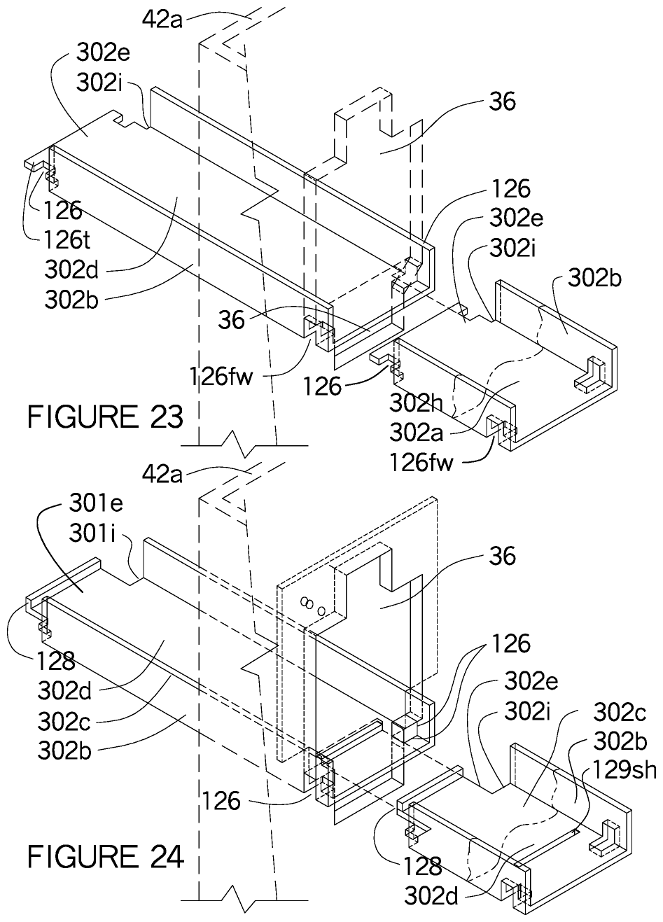

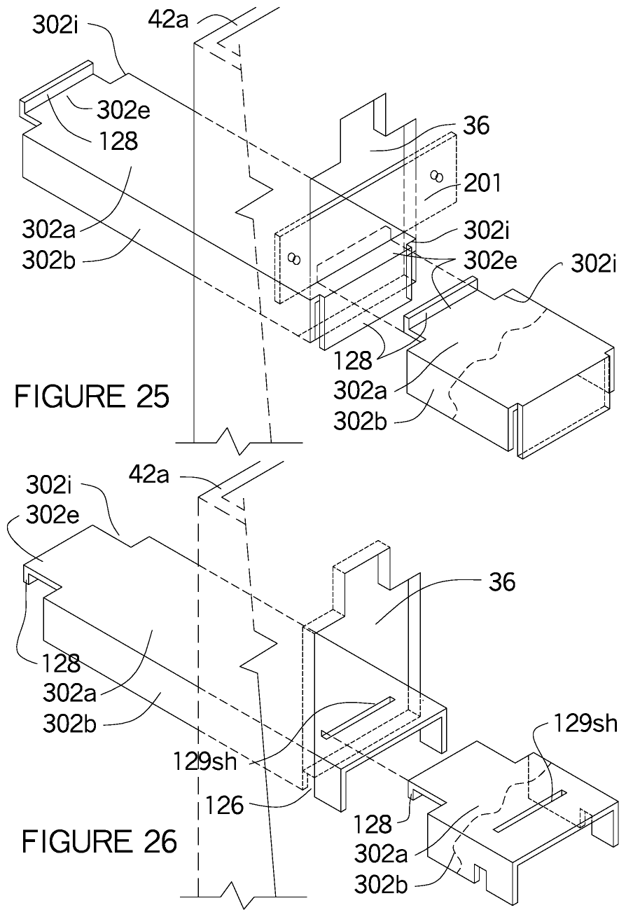

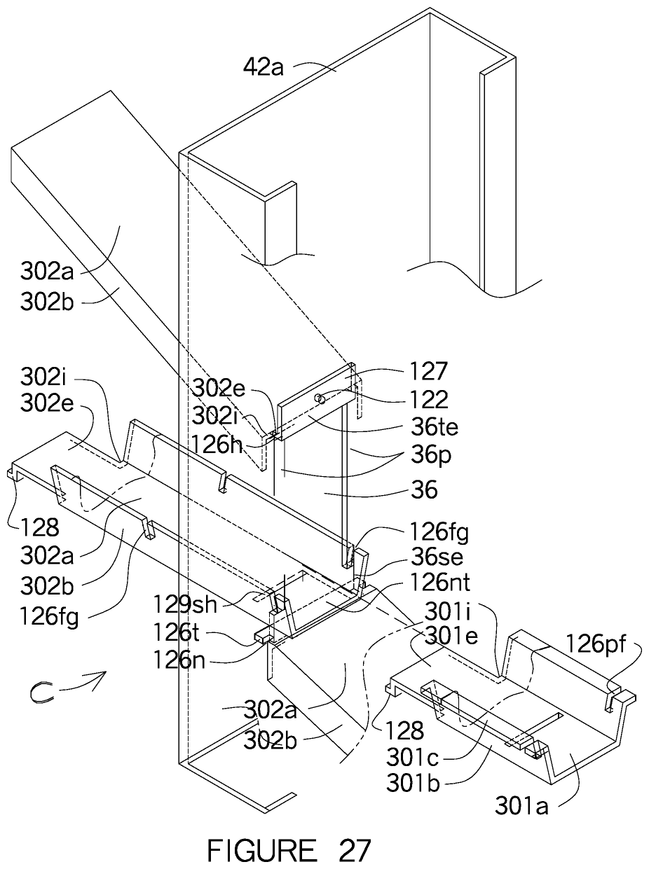

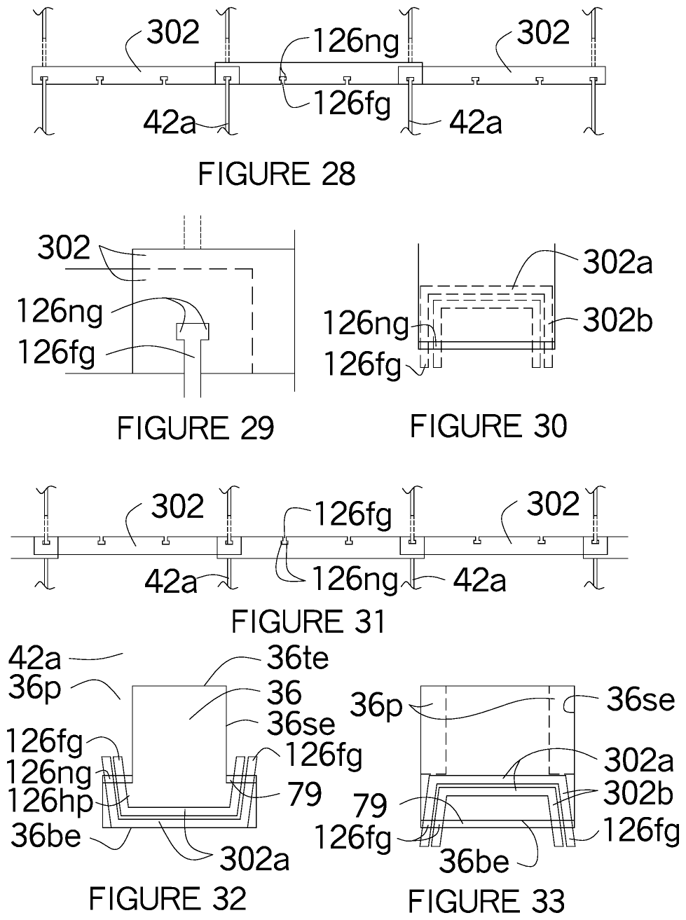

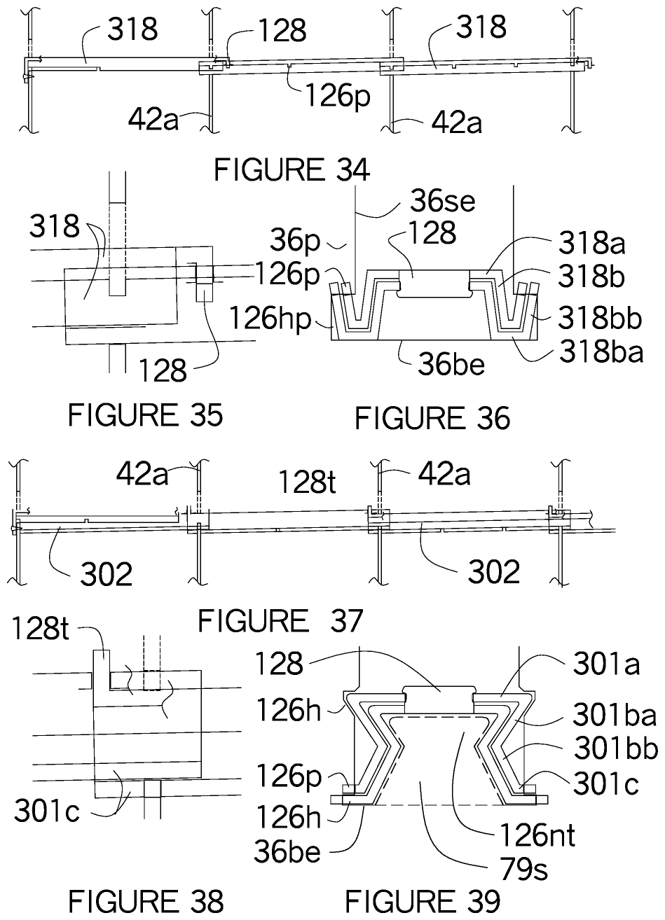

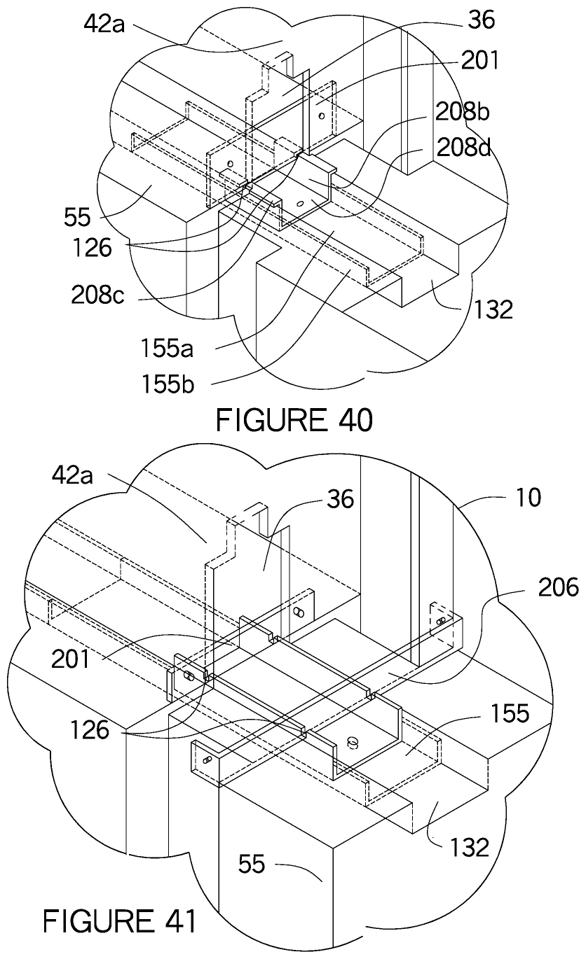

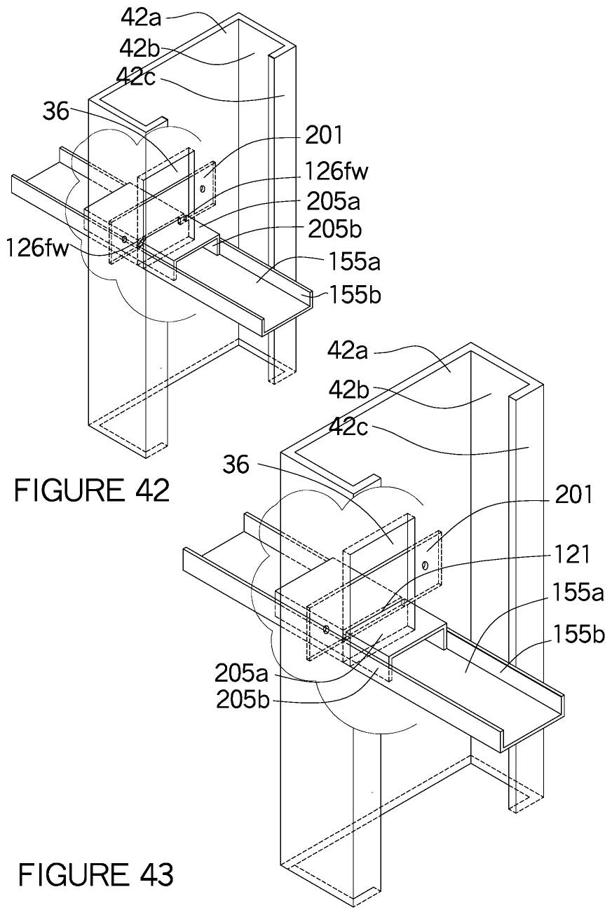

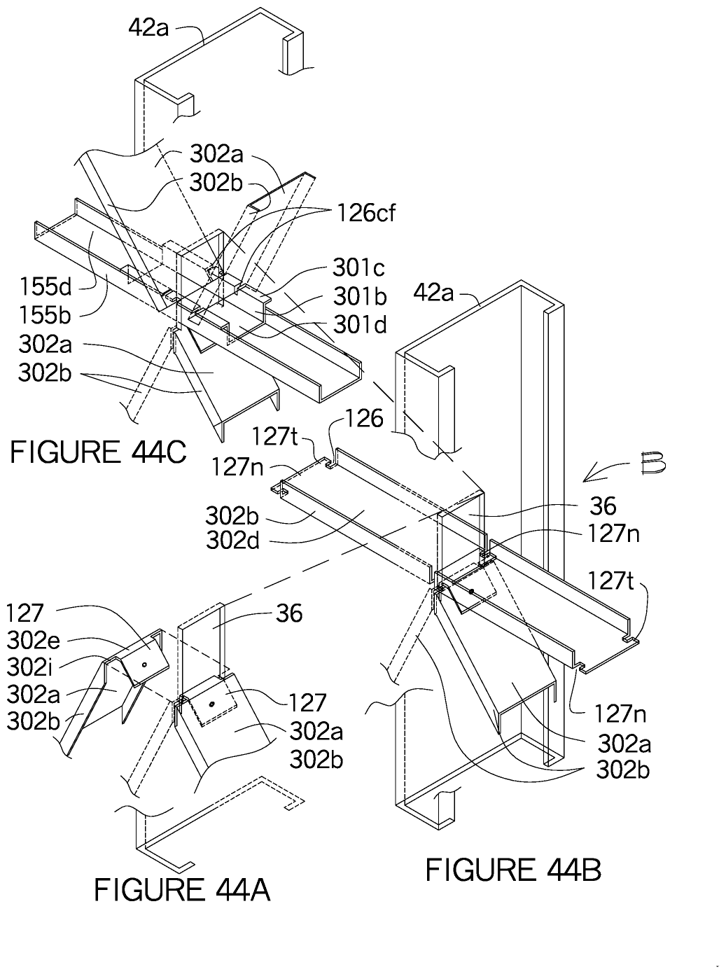

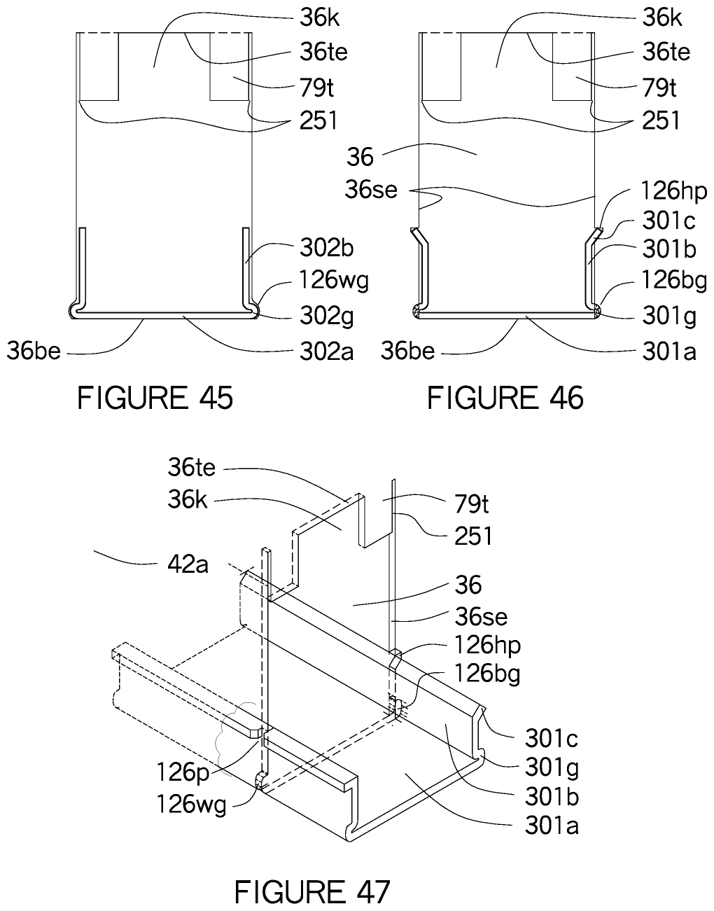

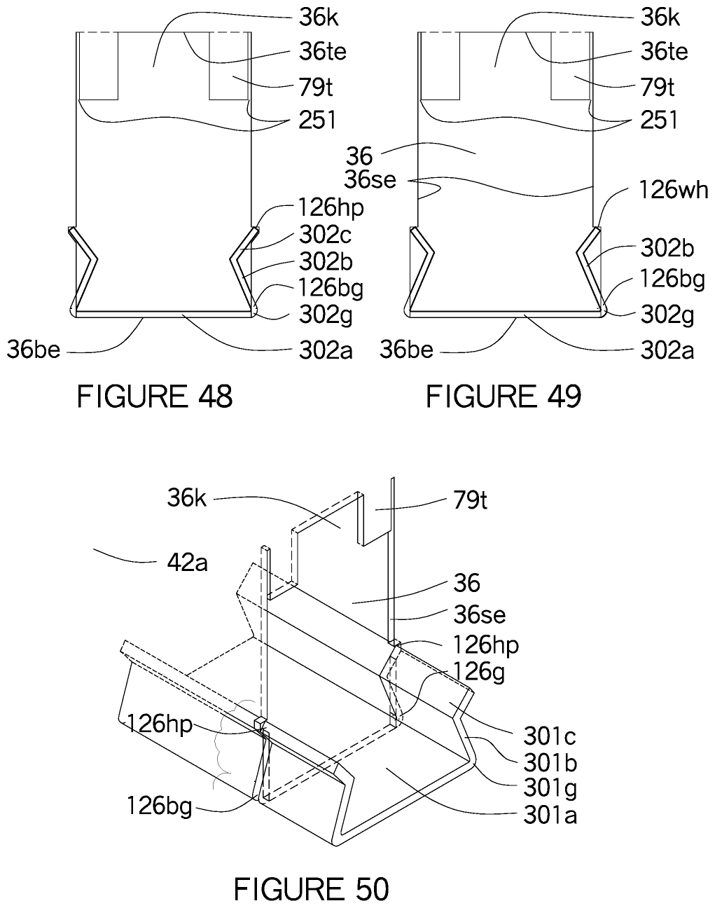

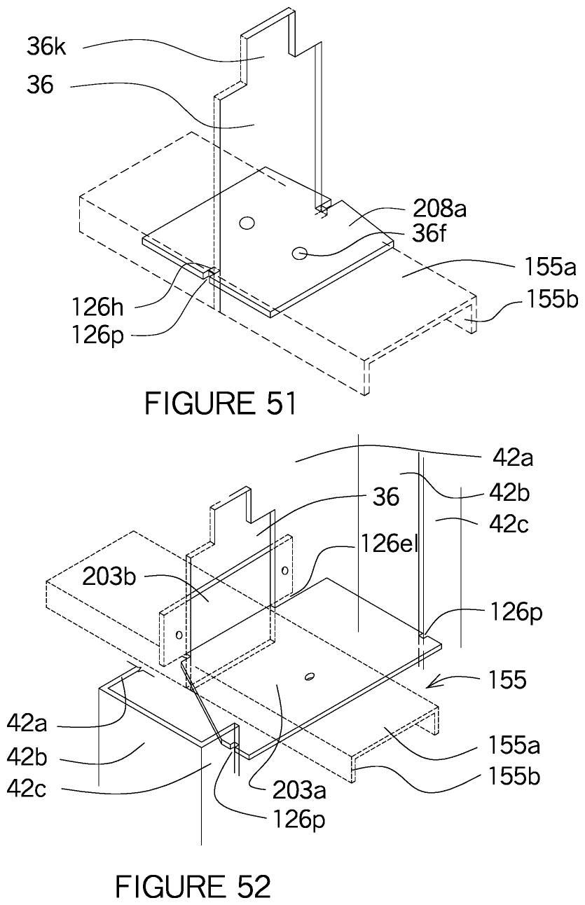

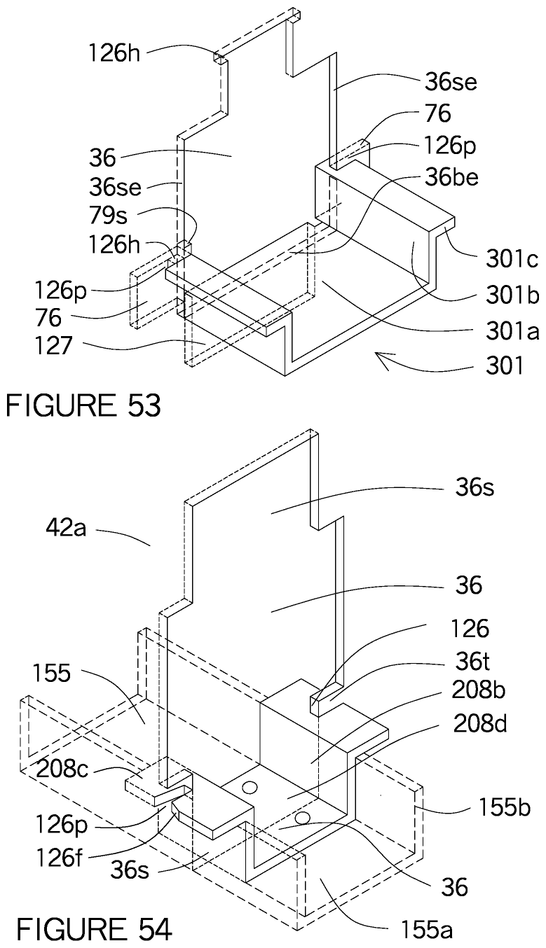

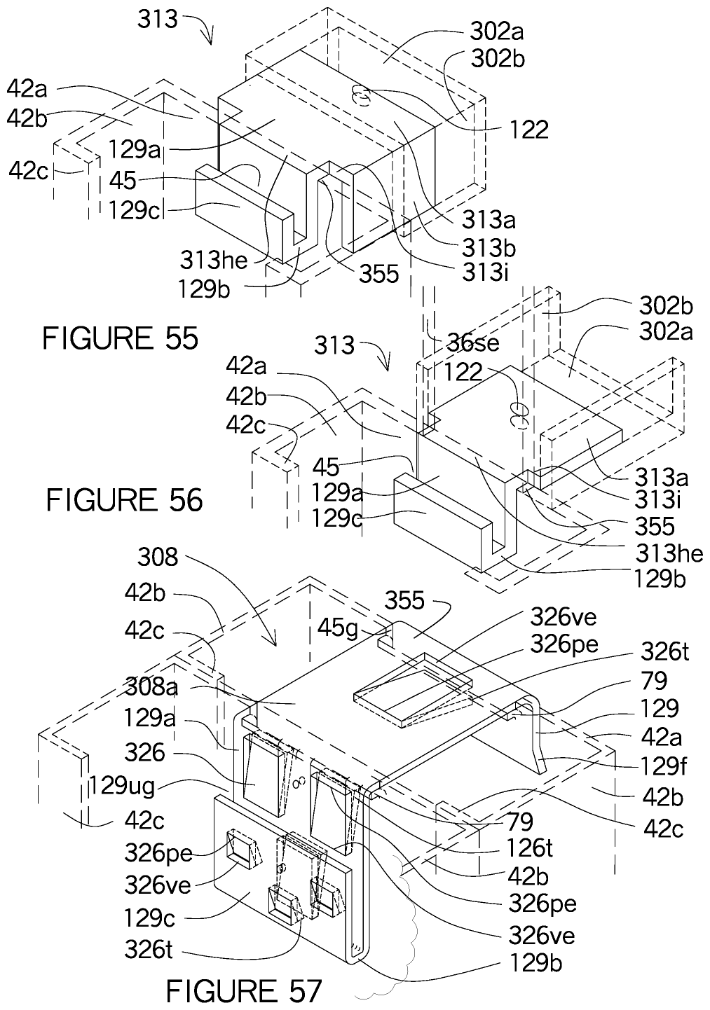

FIG. 51 is the same FIG. 18 as shown in provisional application U.S. 62/175,191 dated Jun. 12, 2015 but enlarged as attached to this patent application.

FIG. 51 shows a bridging connector with bridging notches extending over the web of the U-shaped bridging channel.

FIG. 52 is the same FIG. 20 as shown in provisional application U.S. 62/175,191 dated Jun. 12, 2015 but enlarged as attached to this patent application

FIG. 52 shows an enlarged bridging connector with bridging notches engaging the perimeter side edges of the aperture and the lip edges of the support member.

FIG. 53 shows is the same FIG. 246 as shown in provisional application U.S. 62/298,762 dated Feb. 23, 2015 and shown as FIG. 27 in application U.S. Ser. No. 15/430,781 filed Feb. 13, 2017 as attached to this patent application. FIG. 53 shows the reverse lip bracket ending at the aperture of the support member with the flanges and web of the reverse lip bracket overlapping the web of the support member.

FIG. 54 is the same FIG. 46 as shown in provisional application U.S. 62/175,191 dated Jun. 12, 2015 as attached to this patent application. FIG. 54 shows a smaller reverse lip bracket fitting into a smaller U bridging channel installed in the key hole of the aperture in a support member. FIG. 54 shown in the provisional application as FIG. 46 is the same configuration as FIG. 22 except the hole in the support member has a lower hole connected to a larger hole for a smaller width bracing channel to fit through and a smaller size U shaped bracket with extending lips, so the lips with notches can fit into the side edges of the smaller sized hole.

FIGS. 55 & 56 is the same FIGS. 111 & 112 as shown in provisional application U.S. 62/175,191 dated June 12, 2015 and shown as FIGS. 13 & 14 in application U.S. Ser. No. 15/090,460 filed Apr. 4, 2016 as attached to this patent application. FIG. 55 shows an add-on hook clip with a U-shape profile being attached to a U shaped channel. FIG. 56 shows an add-on hook clip having only its end attached to horizontal bracing channel.

FIG. 57 is the same FIG. 164 as shown in provisional application U.S. 62/242,705 dated Nov. 16, 2015 and shown as FIG. 17 in application U.S. Ser. No. 15/295,172 filed Oct. 17, 2016 as attached to this patent application. FIG. 57 shows an isometric view of a U-shaped clip spanning over the end of two support member connected at the web and ledges and the tabs of the punch out tabs in the U-shaped clip.

### DESCRIPTION OF THE PREFERRED EMBODIMENTS

Various shapes of horizontal spacing-bracing members are shown throughout the application having different means to connecting a spacing-bracing member or several spacing-bracing members together to adjacent metal support members.

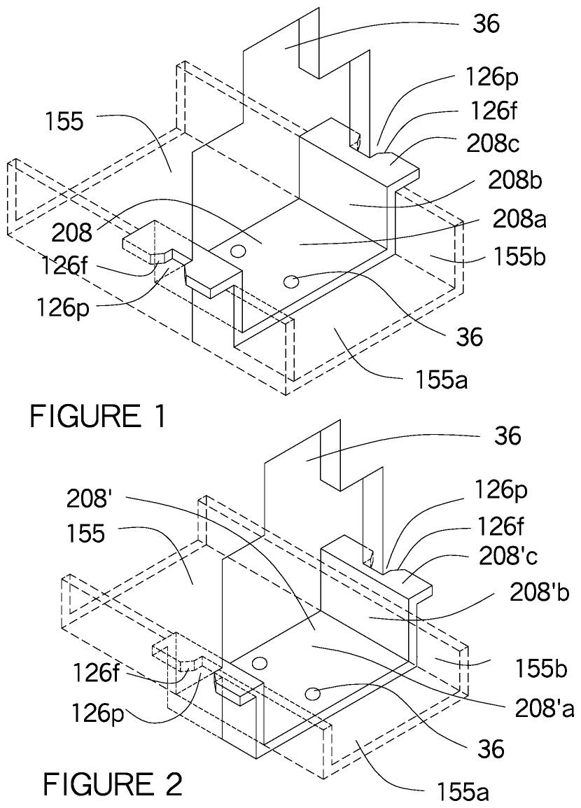

FIG. 1 shows the horizontal bracing channel as a horizontal U channel 155 where the interior side is facing upwards typically spanning between the holes 36 in the support channels shown as C channel 42. The multi-plane bracket 208 is described as a reverse lip bracket 208 having the exterior side fitting between the interior side of the flanges 155b of the horizontal U channel 155 so that the lip notches 126p on both sides of the lips 208c engage the side edges of the hole 36 and extend past the edge of the hole 36 along with the flares 126f that are angled. The flares 126f are angled so the reverse lip bracket 208 can glide into the side edges of the hole 36 easily as the reverse lip bracket 208 is inserted in a vertical orientation and then rotated into a horizontal orientation so the lip notches 126p engage the side edges of the holes 36. The horizontal bracing channel and the reverse lip bracket 208 are additionally secured by fasteners between the webs 155a & 208a thereby securing the horizontal bracing channel, the reverse lip bracket 208 and the hole 36 together at the support channel. The multi-plane bracket 208 can also be used to connect two horizontal bracing channels together. FIG. 2 is similar to FIG. 1, however the reverse lip bracket 208 shown with its lip notches 126p are installed in the hole 36 of the support channels first, then the web 155a of the horizontal U channel 155 are installed between the two parallel flanges 208b of the reverse lip bracket 208 are secured together at their webs 155a & 208a. The multi-plane bracket 208 is rotated into the hole 36 with the lip notches 126p engaging the side edges of the hole 36. The reverse lip bracket 208 and the horizontal U channel 155 can be reversed, where the interior sides are turned downward so the web 155b & 208b extend downward from the web 155a & 208a. The horizontal U channel 155 in both FIG's can also be a reverse lip channel 156 that has the lip 156c with the lip notch 126p at the free end and a reverse lip bracket 208 can also be a reverse lip channel 156. When the reverse lip channels 156 overlap each other, the notches at the end of each reverse lip channel 156 intersect the same hole and the lip notches are indented from the ends. In addition a reverse lip channel 156 with sloped flanges and lip notches can fit into or over another reverse lip channel 156 with rectilinear flanges and lip notches.

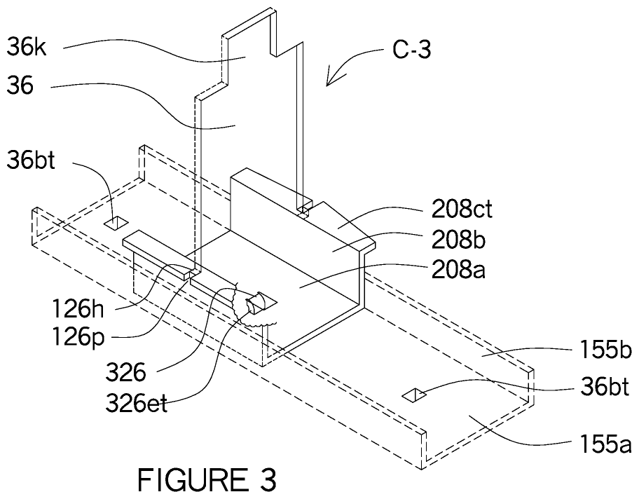

The various brackets shown in FIG. 3 through FIG. 2 all very in shape and size and brackets show notches 126 at various locations on the brackets. Since this application was originally filed other provisional patent applications has shown notches 126 in the side edges of the holes, notches in the side edges of the lips of the support member or notches in the web. These notches are all vertical oriented notches and the notches shown in this provisional patent application are horizontal oriented notches 126. When the vertical notches as described above intersect the vertical notches 126 then the two notches interlock so the notches to not allow the brackets to move vertically or laterally forming a self-locking connection without requiring fasteners to make the connection.

FIG. 3 is an isometric view of a reverse lip bracket 208 installed over a horizontal bracing channel 155 where the ventral side is facing upward with the web 155a resting on the bottom edge of the hole 36 with the flanges 155b against the hole side edges 36se. The dorsal side of the reverse lip bracket 208 has the web 208a and flanges 208b abutting the ventral sides of the horizontal bracing channel 155 with the lips 208c extending outward with lip notches 126p shown inserted into the hole notches 126h so that the horizontal oriented lip notches 126p interlock with the vertical oriented hole notches 126h. In addition, tab holes 36t in the web 155a of the horizontal bracing channel 155 and the punch out tabs 326 in the web 208a of the reverse lip bracket 208 are aligned so the downward oriented extended tab 326t can intend into the tabs holes 36t interlocking the reverse lip bracket 208 and horizontal bracing channel 155 together forming a self-locking screw-less framing connection.

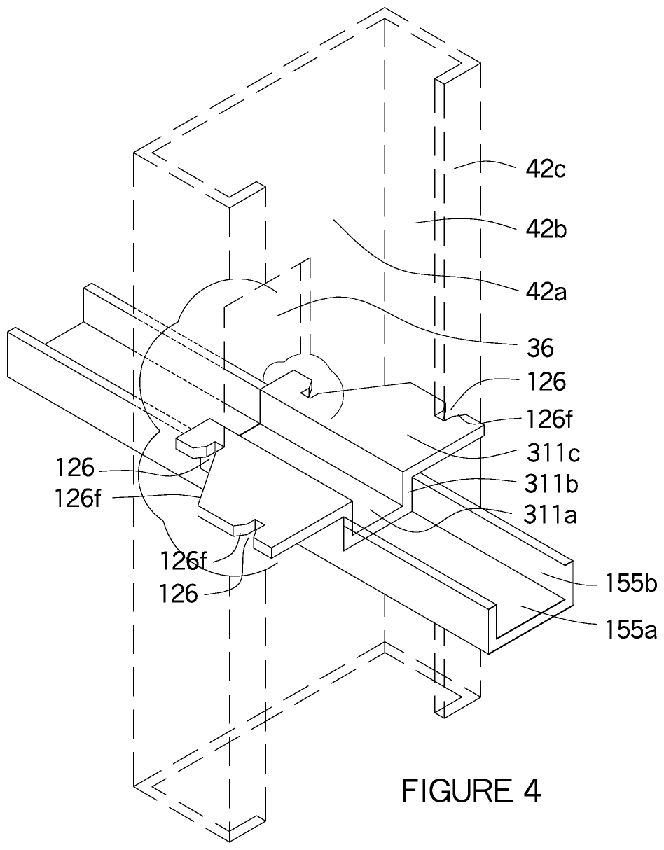

FIG. 4 shows a butterfly bracket 311 being attached to a support member shown as a C channel 42 and a horizontal bracing channel shown as a U-shaped channel 155 where the web 155a of the U-shaped channel 155 rests on the bottom edge of the hole 36 and the flanges 155b fit against the side edges of the hole 36 in the web 42a of the support member. The butterfly bracket 311 shown having a web 311a and flanges 311b fit tight against the ventral side of the horizontal bracing channel 155 and the lips 311c extend outwardly from its flanges 311b. The lips 311c extend outwardly having notches 126 with flares 126f that are angular where the notches 126 engage both sides of the vertical side edges of the hole 36 and the side edge of the lips 42c of the support member. The lips 311c extend longer away from the flanges 311b as the distance to the lips 42c varies depending on the width of the web 42a and the length of the lips 42c of the support member.

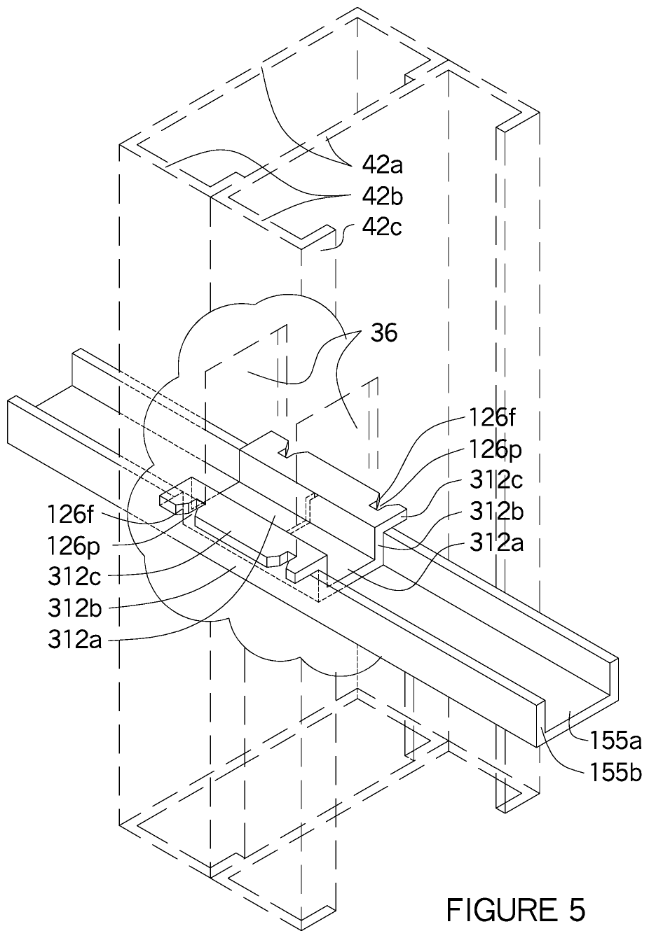

FIG. 5 shows a double reverse clip bracket 312 being attached to two support members shown as a C channel 42 and a horizontal bracing channel shown as a U-shaped channel 155 where the web 155a of the U-shaped channel 155 rests on the bottom edges of the holes 36 and the flanges 155b fit against the side edges of the holes 36 in the webs 42a of the support members. The double reverse clip bracket 312 is shown having a web 312a and flanges 312b fits tight against the ventral side of the horizontal bracing channel 155 and the lips 311c extend outwardly from its flanges 311b. The lips 311c extend outwardly having notches 126 with flares 126f that are angular where the notches 126 engage both sides of the vertical side edges of the holes 36 of two adjoining and adjacent support members thereby engaging two support members using the same double reverse clip bracket 312.

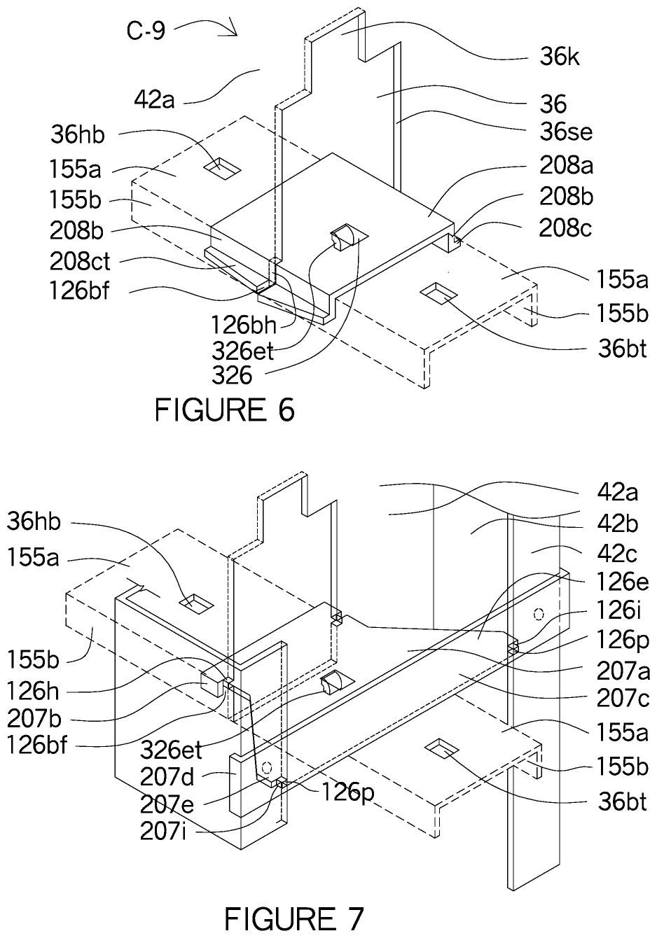

FIG. 6 shows as a U shaped channel 155 facing downward where a one piece multi-plane bracket shown as reverse lip shape bracket 208 has lip notches 126p into the hole side edges 36se of the support member where vertical oriented holes notches 126h intersect the flanges 208b on both sides of the web 42a of the support member. In addition the web 208a has a punch out tab 326 with an extend tab 326t projected downward into the tab hole on the web of the U shaped channel 155.

FIG. 7 shows the L-shaped bracket 203 as a one piece multi-plane bracket shown as an L-shaped butterfly bracket 207 so here the horizontal leg 207a is longer and tapered compared to the L-shaped bracket 203 so the horizontal leg 207a can extend through the hole 36 of the support member. The web 207a passes through the hole 36 having and have a butterfly flange notch 126bf at the web 201a that also extends into the lip of the support member.

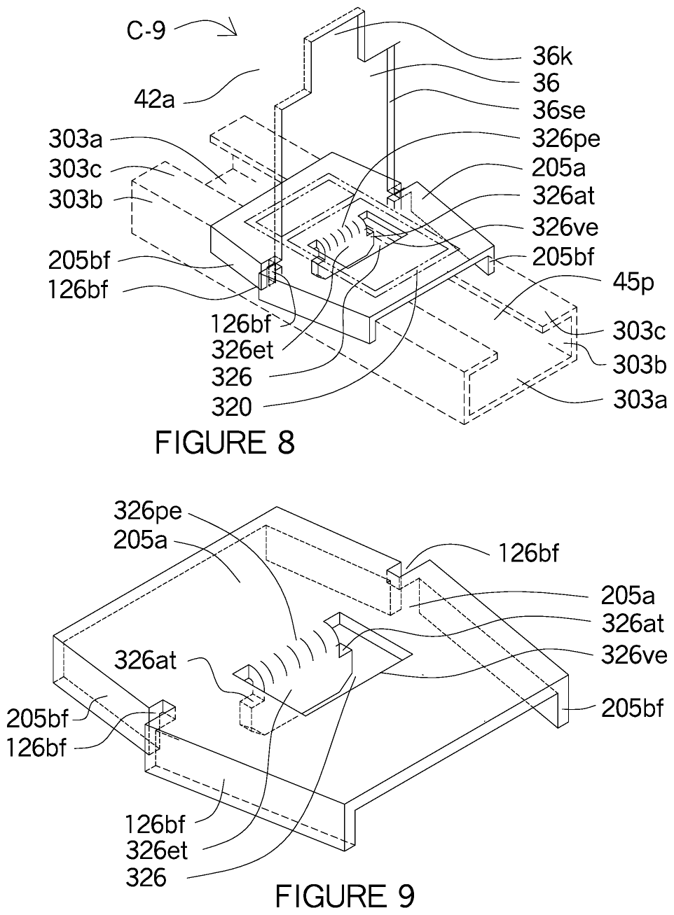

FIG. 8 shows a horizontal oriented C shaped spacer brace 303 spanning between the holes 36 of an array of support members where the dorsal side is a web 303a that rests on the bottom edge of the hole 36 with flanges 303b extending upward from the web 303a and lips 303c extending from the flanges 303b forming a C shape spacer brace 303. A butterfly bracket 205 also shown in FIG. 9 extends over a C shaped spacer brace 303 where the ventral side of the butterfly bracket 205 extends over the lip gap 45p and the lips 303c of the C shaped spacer brace 303 with its flanges 205b extending over the flanges of the C shaped spacer brace 303. The butterfly bracket 205 having a U-shape where the web 205a and flange 205b are notched to form a butterfly flange notch 126bf and where the butterfly flange notches 126bf is inserted into the hole notches 126h at the hole side edges 36se so the hole side edges 36se support the top and bottom planes of the web 205a and the butterfly flange notches 126bf support the vertical planes of both sides of the web 42a at the hole 36. The web 205a of the butterfly bracket 205 is shown having a punch out tab 326 with a vertically downward extending tab 326t inserted into the lip gap 45p between the lips 303c of the C shaped spacer brace 303. The extending tab 326t has arm tabs 326at that are formed from the punch out tab 326 and extend outward so the arm tabs 326at and the width of the extending tabs 326t are slightly greater than the distance in the lip gap 45p. The arm tabs 326at extend under the lip 303 of the C shaped spacer brace 303. The arm tabs 326at become lodged under the lips 303c and against the sides of the extending tab 326t. Another alternate solution is lip notches 126p shown previously in a C channel 42 support member can be installed in the lip 303c of the C shaped spacer brace. When the lip notches 126p are installed in the lip 303c and the extended tab 326t has arm tabs 326at the lip notches 126p and the extended tab 326t become interlocked that allows the butterfly bracket 205 to be secured to the C shaped spacer brace 303 without using fasteners. If the hole notches 126h and the butterfly-flange notch 126bf interlock together, then only the extending tab 326t is required to have a self-locking connection without using screws.

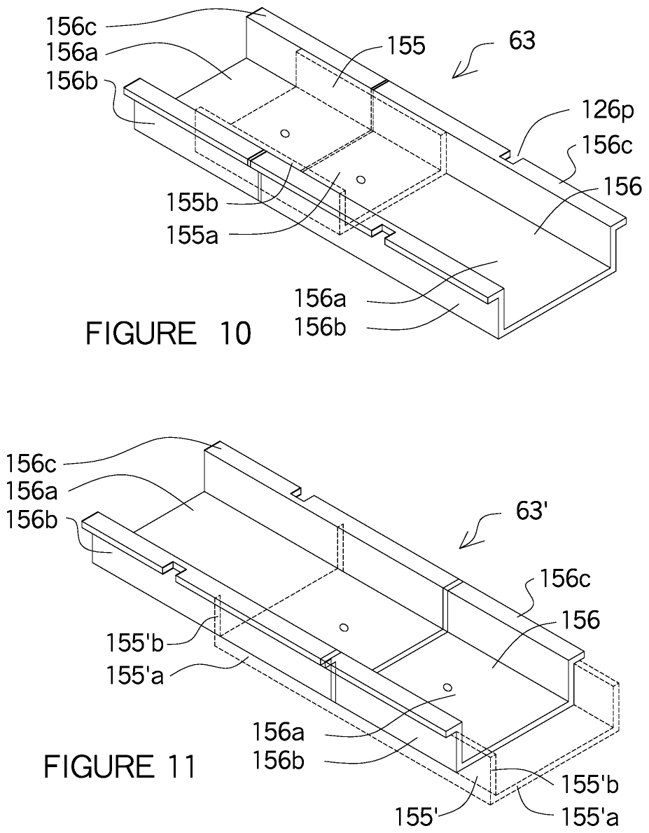

FIGS. 10 & 11 are similar in that a horizontal U channel 155 is used as a coupling 63 and 63′ that connects two longitudinal spacing-bracing members shown as horizontal reverse lip channel 156. In FIG. 10 the longitudinal spacing-bracing member shown as a horizontal reverse lip channel 156 has the interior side of the web 156a and the flanges 156b of both horizontal reverse lip channels 156 facing upwards. The interior side of the coupling 63 comprises the open side of horizontal U channel 155 having the exterior side of the web 155a and flanges 155b being inserted into the interior side, the open side, of the horizontal reverse lip channels 156 where the web 155a of the horizontal reverse lip channels 156. In FIG. 11 the interior side of the coupling 63′ comprises of the open side of the horizontal reverse lip channel 156 and the horizontal U channel 155′. The exterior side of web 156a and the flanges 156b are received in the open side, the interior side, of U channel 155′ so the exterior side of the web 156a is juxtaposed against the interior side of the web 155′a of the horizontal U channel 155′. The horizontal U channels 155 and 155′ are secured to the horizontal reverse lip channels 156 with metal screws, nut and bolts, or like fixtures.

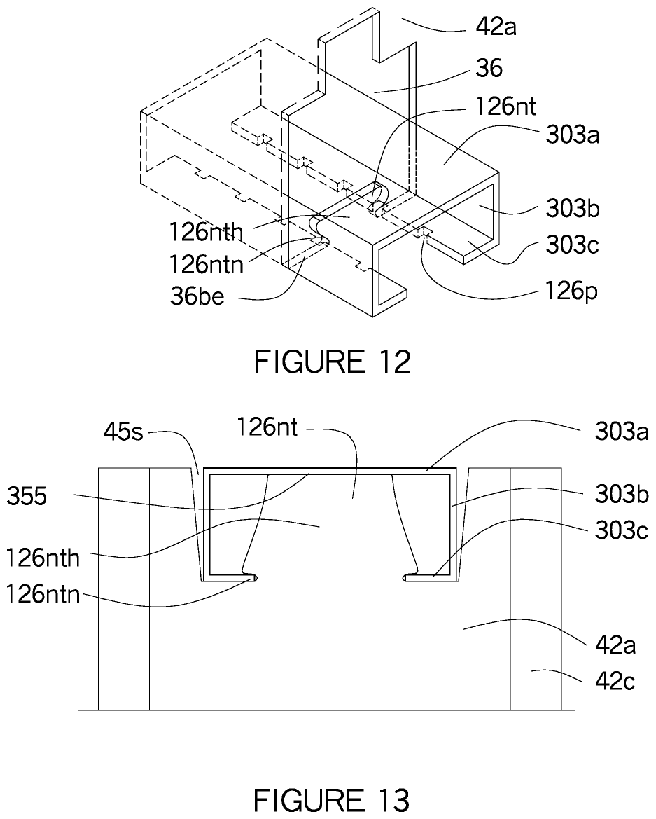

FIG. 12 shows the C shaped spacer brace smaller and passes through the hole 36 in a support member. The C shaped spacer brace is shown having the exterior side of the lips 303c supported on the hole bottom edge 36be with the side edges of the lip 303c extending against the notch 126n of the notched-tab 126nt. If the C shaped shaped spacer brace 303 will not be allowed to slide horizontally.

FIG. 13 is a sectional view with the exterior side of the web 302a of the U shaped spacer brace 303 is shown even with the top edge of the support member and the notched-tab 126nt has it top edge being the anchor space 355 for the interior side of the web 303a to rest on. In addition the flanges 303b extend into the web-gap 45w allowing the lips 303c to flex and become engaged into the notch 126n of the notched-tab 126nt.

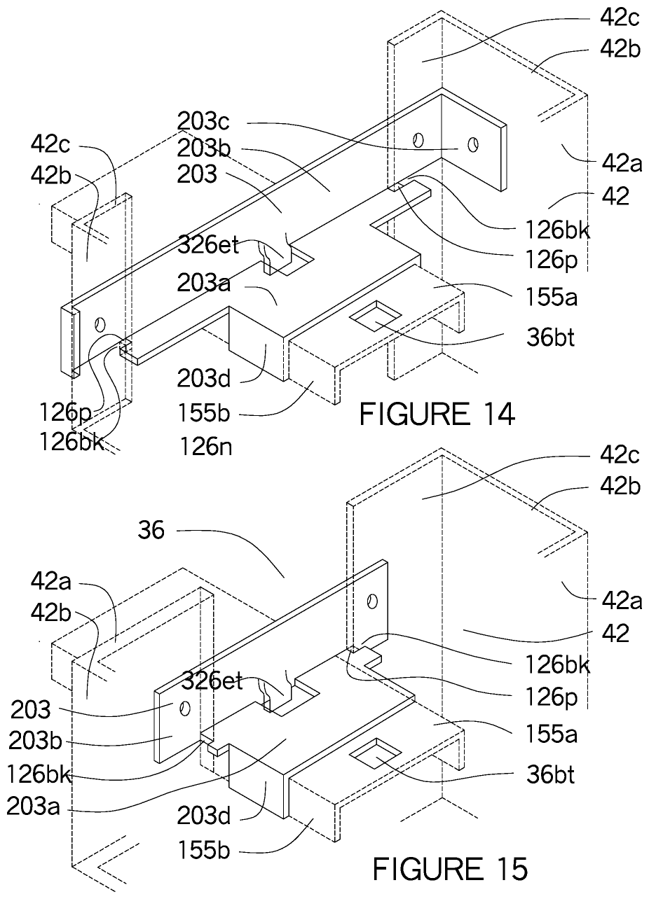

FIG. 14 shows an isometric view a one piece bracket shown as an L-shaped bracket 203 where one side is connected to the horizontal bracing channel 155, connected by a ½ notch 126a that engages the lip of the support member and the vertical side becomes the opposite side of the ½ notch 126a engaging the outer side of the lip 203c. The U-shape horizontal bracing channel 155 is shown with its dorsal side facing upwards passing between the lip 42c of a support member and where the dorsal side is the web 155a having an array of tab holes 36t with the ventral side having the bottom longitudinal edges of the flanges 155b resting on the bottom edge of the hole 36 in the support member. The L-shaped bracket 203 is shown having a horizontal leg 203a resting on the dorsal side of the horizontal bracing channel 155a with a vertical leg 203b that extends over the dorsal side of the lips 42c of the support member having the ends 203c wrap around the flanges 42b of the support member. The vertical leg 203a is shown having an extending tab 326t extend vertically downward from the punch out tab 326 so the extending tab 326t can extend into a tab hole 36t shown in an array in the web 155a of the horizontal bracing channel 155. The vertical oriented lips 42c of the support member have lip notches 126c that interest the ½ notches 126n and the vertical leg 203b so that the notches 126n and vertical leg 203b extend beyond the lip notches 126c so the two notches interlock between each other forming a self-locking connection between the L-shaped bracket 203 and the support member. In addition the vertical leg 203a with the extending tab 326t extends into the tab hole 36t forming another self-locking connecting between the L-shaped bracket 203 and the horizontal bracing channel 155.

FIG. 15 is similar to FIG. 14 except here the L-shaped bracket 203 has the 4vertical leg 203b spanning the hole 36 in a support member and the vertical leg 203b is connecting the web 42a.

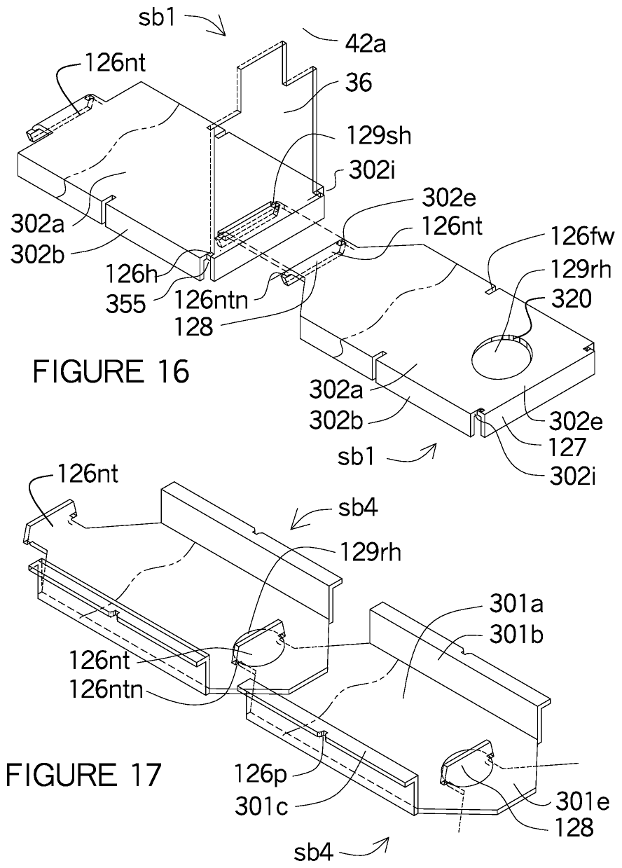

FIG. 16 shows two U shaped spacer braces 302 having a web 302a with two flanges 302b extending downward from the longitudinal sides of the web 302a. The left U shaped spacer brace 302 shows a notched-tab 126nt extending downward from the web extension 302we. The opposing end of the web 302a shows a receiver slot hole 129sh located near the hole bottom edge 36be. The web 302a is indented 302i at the hole 36 with the indentation 302i extending into the flanges 302b. The flanges 302b and the web 302a rest against the plane of the web 42a of the support member on one side and the web 302a, and the web 302a forms a hook finger 127 that extends over the hole bottom edge which is the anchor space 355 for the inside plane of the hook finger 127 to rest against from the opposing side of the web 42a from the support member.

The right spacer brace 302 has a hook tongue 128 with a notched-tab 126nt extending downward, however the extension 302we has tapered side edges. The tapered side edges are angled so the notched-tab 126nt can fit into the round-hole receiver 129rh as shown in the web 302a on the opposite end of the right U shaped spacer brace 302. The round-hole receiver 129rh has ridges 320 at the side edges of the round-hole receiver 129rh. The ridges 320 are spaced at intervals to allow the notched-tab 126nt to fit between the ridges 320 to stop the notched-tabs from rotating. The right U shaped spacer brace 301 has the tapered side edges to rotate when the notched-tab 126nt is inserted into the round-hole receiver 129rh. Once the notched-tab 126nt is located at the proper angle between adjacent U shaped spacer braces 302 the head 126nth can be bent having the head 126nth being secured in the round-hole receiver 129rh. The web extension can be short or long and the receiver hole can be a receiver slot hole 129sh or a round-hole receiver 129rh so the notched-tab 126nt can be swiveled to be oriented at an angle. Additional round-hole receivers 129rh can be added to the web 302a so additional hook tongues 128 having notched-tabs 126nt (not shown) could be inserted from a crossing spacer brace from a perpendicular wall having support members. Any shape spacer brace could be used to form the pivotal configuration as explained above. For example (but not shown) a C shaped spacer brace 303 could be used and a notched-tab 126nt could be installed in the support member or the floor spacer brace could just have a groove at the flanges for the web 42a of a support member to fit into. The receiver slot hole 129sh with the notched-tab 126nt can be used as an end connections between abutting lengthy spacer braces between support members not just short segmented section to form curvilinear walls. When the U shaped spacer braces 302 are wider than the hole 36, the plane on both side of the hole 36 can be inserted into the flange-web notch 126fw in the flange 302b and web 302a of the spacer brace 302. If the spacer brace was a reverse lip spacer brace 301 the lip notches 126p would also give additional support at the hole 36 intersection. Another alternative solution in FIG. 16 shows the flanges 302b and the web 302a (referred to also as a web-flange notch 126fw that shows the hook FIG. 127 where the web 302a has an extension 301e that extended over the hole bottom edge 36be and the hook finger 127 extension downward. The hole bottom edge 36be and the hole side edge 36se form a hole notch 126h at the corners of the hole 36. When the web 302a of the U shaped spacer braces 302 extends into the hole notch 126h, the U shaped spacer brace 302 will not move up and down within the hole notch 126h.

FIG. 17 is similar to FIG. 16 except the spacer brace is shown as a reverse lip spacer brace 301 where the underside of the web 301a is against a floor and the flanges 301b extend upward with lips 301c extending outward. The lips 301c are shown having lip notches 126p shown previously being installed in the web notches 126w of the support member. The reverse lip spacer braces 301 are shown having an extension 301e at both ends of the web 301a with the left end having a notched-tab 126nt extending upward with the opposite end having a round-hole receiver 129rh located near the extension 301e. Both extensions 301e are tapered so when the notched-tab 126nt is inserted into the round-hole receiver 129rh, the notched-tab 126nt is allowed to swivel within the round-hole receiver 129rh. The head 126nth can be bent once the reverse lip spacer brace 301 is oriented to the desired angle to then be secured to the floor for installation of the support members that fit into the lip notches 126p and into the web notches 126w in the L-shaped gap 45e. When completed drywall or other types of wall board can be mounted to the support members to form a curved wall. On the other hand, the hook tongue 128 and the receiver slot hole 129sh can be used at the end of a reverse lip spacer brace 301 in lieu of the notched-slide extension 126se at the web 301a that connects to hole side edge 36se,

FIG. 18 is similar to FIG. 17 except a U shaped spacer brace 302 has a wider web 302a than the web 301a of the reverse lip spacer brace 301 in FIG. 17. The middle U shaped spacer braces 302 shows the base of a support member between the flanges 302b bearing on the web 302a of the U shaped spacer brace 302a. The U shaped spacer brace 302 can be manufactured in short segments or longer lengths where additional support members can be installed to the U shaped spacer brace 302 by fastening screws (not shown) from the support member flanges 42b into the flanges 302b of the U shaped spacer brace as standard metal framing are presently connected. The longitudinal ends of the U shaped spacer brace 302 are shown having web extension 302we extend from the webs 302a to notched-tabs 126nt extending upward from the hook tongue at one end and a receiver hole 129h installed in the web extension 302we at the opposing end. The web extensions 302we can have receiver holes 129h or notched-tab 126nt at both ends depending on the configuration of the wall framing. In addition, the flanges 302b can be formed as tabs 302bt that can be bent inward to secure the lip 42c and web 42a between the bent tabs or have a flange-bulge notches 126fg in the flanges 302b to a corresponding bulges in the flanges 42b of the support member to the flange-bulges notches 126fg in the flanges 302b of the U shaped spacer brace 302. The three short U shaped spacer braces 302 can be used to form serpentine curvilinear walls or just connecting different wall framing segments together.

FIG. 19 shows a reverse lip spacer brace 301 having a web 301a with flanges extending vertically approximately coplanar to the holes side edges 36se with lips 301c having lip notches 126p and where an adjoining second reverse lip spacer brace 301 overlaps the first reverse lip spacer brace 301 and described previously in U.S. Ser. No. 15/449,250. In order to overlap each other the reverse lip spacer braces 301 the width of the web 301a, the length of the flanges 301b or the lips 301c will vary depending on shape and snugness between reverse lip spacer braces 301. This continuation in part application shows the hole notches 126h at the hole side edges 36se as shown in pending application Ser. No. 15/430,781 being into this CIP, but is only shown at the furthers left hole rather than all the holes 36 in the support member for clarification purposes. The lip notches 126p at the left support member show the lips 301c with the lip notches 126p shorter while the hole notches 126h have a deeper depth so the lip notches 126p will extend deeper into the hole notch 126h as shown in U.S. Ser. No. 15/430,781 therefore eliminating any vertical and horizontal movement within the hole notch 126h. All the holes 36 can have hole notches 126h to eliminate vertical movement at the holes 36 or maybe installed at the hole side edges 36se without the hole notch 126h. At the right no hole notches 126h are shown as the hole notches 126h can be a double lip notch 126dp or a double hole notch 126dh as shown in Ser. No. 15/449,250. If the hole notch 126h is wide enough for only one lip notch 126p the lower reverse lip spacer braces 301 would have its lip notch 126p not fit into the hole notch 126h and only the upper reverse lip spacer brace at the lip notch 126p would only engage the hole notch 126h keeping the lower spacer brace 301 tight against the hole bottom edge 36be. As mentioned in U.S. Ser. No. 15/449,250 the width of upper oriented spacer brace has a narrower width web 301 with longer flanges 301b and longer lips 201c to fit into the lower reverse lip spacer brace 301.

FIG. 20 is similar to FIG. 19 except the flanges 301b are angular allowing two overlapping reverse lip spacer braces 301 to fit against each other as described in pending application U.S. Ser. No. 15/449,250. The web 301a, flanges 301b and lips dimensions can vary depending how the upper reverse lip spacer brace 301 wants to fit into the lower reverse lip spacer brace 301. The hole notches 126h can be a double hole notch 126dh and the lips 301c can be double requiring a double lip notch 126dp as for FIG. 19. FIG. 445 like FIGS. 19 & 20 does not show a gap 45 between the lips 301c because the web 301a is narrower, the flanges 301b are longer in length and the lips 301c are wider in width as the longitudinal edges of the lips 301c are shown aligned.

FIG. 21 is similar to FIG. 20 except the two overlapping reverse lip spacer braces 301 is shown face down with the left reverse lip spacer brace 301 having the lips 301c supported by the hole bottom edge 30be. The lips 301c have lip notches 126p that extend inward from the longitudinal edge of the lips 301c so the web 42a of the support member fits against the back edge of the lip notches 126p with the side edges of the lip notch 126p abut both side planes of the web 42a of the support member. The second reverse lip spacer brace 301 also extends through the hole 36 overlapping the first reverse lip spacer brace 301 at a slight angle, in order to have the longitudinal edges of the lips 301c fit through the hole 36 and have the back edge of the lip notches 126p engage the hole side edges 36se. As in FIG. 19 the width of the web 301a and the width of the flanges 301b and lips 301c will be wider in order to have both reverse lip spacer braces 301 fit tightly together and may have fasteners (not shown) to additionally secure the reverse lip spacer braces 301 together. As discussed earlier hole notches 126h may be installed at the hole side edges 36se either as a single notched hole 126h or as a double wide notched hole 126dh.

FIG. 22 shows the same profile as shown in FIG. 23, however the first reverse lip spacer brace 301 shows the lip notch 126p starting at the longitudinal edge of the lip 301c extending the full width of the lip 301c with the lip notch 126p continuing into the flange 301b or flange notch 126fg forming a continuous lip-flange notch 126pf. The lip-flange notches 126p at the first reverse lip spacer brace 301 is installed at a slight angle so one lip-flange notch 1216pf has the hole side edge 36se installed into the lip-flange notch 126pf allowing the side edges of the lip-flange notch 126pf to engage the longitudinal planes of the web 42a of the support member. When the lip-flange notches 126pf extends below the hole bottom edge 36be another adjacent reverse lip spacer brace 301 with only lip notches 126p at both lips 301c can overlap the first reverse lip spacer brace 301. The second reverse lip spacer brace 301 can be identical in shape and size, that is the web 301a, flanges 301b and lips 301c can be the same width and length and still form a secure connection between two adjoining reverse lip spacer braces 301. To form a tighter connection between the first and second reverse lip spacer braces 301, the web 301a of the overlapping reverse lip spacer brace 301 should be wider in order to have a tight connection at the webs 301a using fasteners between the first and second reverse lip spacer braces 301. In U.S. Ser. No. 15/430,781 hole notches 126h are used at the corner of the hole side edges 36se and hole bottom edge 36be for the lips notches 126p to fit into or the hole notches 126h can have protrusions to also secure the reverse lip spacer brace 301 from vertical movement.

FIGS. 23 & 24 both show a U shape spacer brace 302 having a web 302a being support at the hole bottom edge 36be of a support member with flanges 302b extending upward where the web 302a. The right longitudinal end of the U shape spacer brace 302 shows a flange-web notch 126fw at the intersection of the web 302a and flange 302b forming a continuous notch between the web 302a and flange 302b. FIG. 23 shows the flange-web notch 126fw support at a hole bottom edge 36be having a diagonal bottom edge. FIG. 24 shows a key hole 36k at the hole bottom edge 36be where a smaller size hole is connected to the larger hole. The back edge of the flange portion of the flange-web notch 126fw is support at the hole bottom edge 36be of the larger hole 36 and the web portion of the flange-web notch 126fw has the side edges of the key hole 36k securing the web portion of the flange-web notch 126fw. FIG. 23 shows the left longitudinal end configuration having a notched-tab 126nt where the notched-tab 126nt longitudinal end is installed at the hole bottom edge 36be with the notches 126 secured at the hole side edges 36se prior to the flange-web notches 126fw longitudinal end of the adjacent U shaped spacer brace 302 is installed in the hole 36 of the support member. FIG. 24 shows a hook tongue 128 having an extension 302e with the tongue portion extending upward from the hole bottom edge 36be requiring the hook tongue longitudinal end to be installed prior to adjoining the second U shaped spacer brace 302 shown to the left with the flange-web notch 126fw into the hole 36. The hook tongue 128 is shown extending upward for a vertical plate or separation can be installed across the hole 36 opening. The same configuration can also have the tongue end of the hook tongue 128 extending downward.

FIG. 25 shows two U shaped spacer braces 302 having a web 302a with flanges 302b extending downward from the longitudinal side edges of the web 302a with the left longitudinal end has indentations in the flanges 302b and web 302a with the remaining portion of the web 302a having an extension 302e being the arm of the hook tongue 128 with the end of the hook tongue extending upward as also described previously. The right longitudinal end of the U shaped spacer brace 302 also has the indentation at the flanges 302b and web 302a with the remaining portion of the web 302a having an extension 302e that extends over the hole bottom edge 36be and being the arm of a hook finger 127 that extends against the web 42a of the support member while the longitudinal ends of the flanges 302b supports the opposing plane of the web 42a. The tongue end of the hook tongue 128 extends upward against a flat plate 201 that completes the U shaped spacer braces 302 from moving laterally as well as vertically as the flat plate 201 has fasteners to secure the web 42a and U shaped spacer braces 302 together. As mentioned earlier the flat plate 201 can be used as a fire stop separating the air gap that exists between adjacent support members.

FIG. 26 shows an isometric view of two U shaped spacer braces 302 having a web 302a with flanges 302b extending downward from the longitudinal side edges of the web 302a with the left longitudinal end with the flanges 302b and web 302a being indented with an extension 302e forming the arm of a hook tongue 128 where the tongue end extends downward along with the flanges 302b. The opposing longitudinal end of the U shaped spacer brace 302 shows flange notches 126fg with the opening beginning at the longitudinal edges of the flanges 302b with the side edges extending toward the web 302a and indented from the right longitudinal end allowing the side edges of the flange 302b have enough bearing support at the right longitudinal end of the flange 302b. In addition the right longitudinal end shows a receiver slot hole 129sh to the left of the hole 36. The right longitudinal end of the left U shaped spacer brace 302 is installed in the hole 36 by first installing the U shaped spacer brace 302 at a slight angle so the flange notches 126fg can engage the hole bottom edges 36be before the adjacent U shaped spacer brace 302 with the hook tongue 128 with the tongue end can be inserted into the receiver slot hole 129sh. As stated earlier the U shaped spacer brace 302 or reverse lip spacer brace 301 can have various shapes as well as various types of receivers, notches and hook tongues to form additional configurations.

FIG. 27 shows two horizontally oriented U shaped spacer braces 302 intersecting at hole 36 where the right longitudinal end of the web 302a is supported at the hole bottom edge 36be with the longitudinal side edges have flanges 302b that extend upward away from the hole bottom edge 36be. The left end has the hook tongue 128 in the web 302a and the right end has the receiver shot hole 129sh for the hook tongue 128 to extend into when connecting adjacent U shaped spacer braces 302 together as previously described. The right longitudinal end has flange notches 126fg where the flange notches 126fg that extend into the hole side edges 36se and the hole protrusion 36p. In application U.S. Ser. No. 15/724,137 hole protrusions 36p are used and are shown here extending into the flanges notches 126fg that secures the U shaped spacer brace 302 from moving laterally as well as vertically. Many different shapes of spacer braces with and without lips can restrict the horizontal and vertical movement within support members. At the hole top edge 36te shows a diagonal oriented U shaped spacer brace 302 where the flanges 302b and web 302a are indented with a hook finger 127 extending from the web 302a across the hole top edge 36te with the finger end extending upward so a fastener 122 can be connected to the web 42a. The extension 302e is inserted into a hole notch 126h or a hole protrusion 36p where the extension 302e so as to form a hole notch 126h to accomplish the same function of preventing horizontal and vertical movement as well as the hook finger 127 and the longitudinal end edge also securing the web 42. At the hole bottom edge 36be the U shaped spacer brace 302 is shown intersecting the hole bottom edge 36be at a diagonal where the longitudinal end of the web 302a shows the notched tab 126nt end fitting against the hole side edges 36se or into a hole notch 126h (not shown). In this case the downward oriented diagonal U shaped spacer brace 302 is inserted into the hole bottom edge 36be first where the longitudinal end has notch tab 126nt where the notches 126n fit against the hole side edges 36se with the tabs 126t and the longitudinal edges of the flanges 302b engage both sides of the web 42a of the support member. After the lower U shaped spacer brace 302 is installed over the hole bottom edge 36be, the first horizontal U shaped spacer brace 302 previously described is installed over the longitudinal end of the notched tab 126nt of the diagonal U shaped spacer brace by installing the U shaped spacer brace 302 at an angle then turned so the flange notches 126fg can engage the underside of the hole protrusion 36p first. The previously mentioned identical U shaped spacer brace 302 with the hook tongue on the left longitudinal end can then be inserted into the receiver slot hole 129sh of the second U shaped spacer brace 302. Obviously different longitudinal ending connections can be used to form a rigid connection between the metal framing members.

FIGS. 28-33 shows elevations, enlargements and sections of metal framing uses a U shape spacer brace 302 having a web 302a with flanges extending from the longitudinal web 302a and with flange gap notches 126fg that extend from the longitudinal open edges toward the web 302a having a T-shape notched gap 126ng extending horizontally from the longitudinal open edges of the flanges. FIGS. 28-30 show the U shape spacer brace 302 having the flanges 302b extending downward to the hole bottom edge 36be in the web 42a of the metal framing support. The hole bottom edge 36be has a ledge 79 extending from the hole bottom edge 36 so the T-shape notched gap 126ng can extend into the ledge 79 where the metal framing support has the ledge 79 facing either left or right giving the U shaped spacer brace 302 more flexibility during the installation. One end of the U shaped spacer brace 302 would have a larger width or narrow web 302a allowing for the U shaped spacer brace 302 to overlap the adjacent U shape spacer brace 302. FIG. 32 & FIG. 33 are similar however the flanges 302b are angular allowing for a possible faster assembly. FIG. 33 shows protrusions 36p extending from the hole side edges 36se forming a protrusion hole notch 36ph where the hole bottom edge 36be, hole side edge 36se and the bottom edge of the hole protrusion 36p to keep the U shaped spacer brace from moving within the hole 36. As mentioned previously when overlapping the longitudinal ends, one longitudinal end will have a wider width to overlap the adjacent U shaped spacer brace 302. In addition, the wider width longitudinal end will have a web flange notch 126wf so the hole protrusion will fit tight against the smaller U shaped spacer brace 302 as well as the larger U shaped spacer brace 302. FIG. 32 has the same U shaped spacer brace 302 profile the U shaped spacer brace 302 has the web 302a resting on the hole bottom edge 36be. The bottom edge of the protrusion 36p is shown have a ledge 79, however that is not required to secure the metal framing support to the U shaped spacer brace 302. The protrusions 36p extend into the flange notches 126f at the flanges 302b. As shown in other overlapping solutions a smaller U shaped spacer brace 302 will fit into and between the flanges 302b of the larger U shaped spacer brace 302.

FIGS. 34-36 shows an elevation, enlargement and section of metal framing having a W-shape spacer brace 318 which is a combination of FIG. 33 & FIG. 34 where the end of the flanges 318bb have a flange notch 126f and where the flange notches 126f extend into the bottom edge of the ledges 79 extending from the hole side edges 36se. The W-shape spacer brace 318 has a web 318a with the first flange 318b extending downward away from the web 318a, then having the flange turn substantially parallel to the web 318 toward the hole side edges 36se with the last bend of the first flange 318b extending upward with the flange notch a126f having the open end engage the bottom edge of the protrusion 36p. A smaller width longitudinal end profile as required as explained above when adjacent W-shaped spacer braces 318 overlap each other. This configuration eliminates horizontal and vertical movement between the W-shaped spacer braces 318, however an extension 318e with a hook tongue 128 having a tongue 128t extend into a hole receiver 129h of the adjacent W-shape spacer brace 318 will also increase the connection strength between the two members.

FIGS. 37-39 shows an elevation, enlargement and section of metal framing is a combination of several spacer braces as the shape is similar to a reverse lip spacer brace 301 having bent flanges with the first flange 301ba extends downward toward the hole bottom edge 36be having an acute angle to the web 301a. The web/flange acute angle connect has the acute angle penetrating the hole side edges forming a hole notch 126h. The first flange 301ba is further extended having an obtuse angle between the first flange 301ba and the second flange 301bb with lips extending outward toward the hole side edges 36se with lip notches 126p extending inward at the longitudinal side edges of the lips 301a. Two adjacent reverse lip spacer braces 301 are shown overlapping each other at their longitudinal ends and where a smaller narrower reverse lip spacer brace 301 is installed into the hole 36 first with the lips 301c having lip notches 126p engaging the hole notches 126h at the hole bottom edge 36be allowing the lip notches 126p to be supported vertically at the top edge of the hole notches. A larger reverse lip spacer brace 301 is installed over the lower reverse lip spacer brace 301 where the acute angle connection described above occurs connecting the larger reverse lip spacer brace 301 to the hole notch 126h. The hole side edges 36se and the hole bottom edge 36be have another hole notch 126p for the lip notches 126p to extend into while the upper reverse lip spacer brace uses only the lip notches 126p to engage the hole side edges 36se. In addition the lower reverse lip spacer brace 301 has an extension 301e at the web 301a with an upward extending tongue 126t to engage the opposing end of the adjacent spacer brace having a hole receiver 129h in the web 301a for the tongue 128t to fit into. An alternative spacing-bracing member connection to the metal framing support is to have the hole bottom edge 36be with a ledge shaft 79s having a notched tab configuration 126nt (shown dashed lines) at the head extending into the longitudinal concave shape of the larger reverse lip spacer brace 301, so the larger side edge profile of the spacing-bracing members extend into the continuous notched tab notch 126cnt forming a concave relationship where the web 301a is in relationship to the top edge of the head of the notch tab 126nt, then having the flanges 301ba bent inwardly in an acute angle to the web 301a then the flanges 301bb are bent away from the flange 301ba forming an obtuse angle or a notch having an equivalent shape of the notched-tab notch 126ntn with the hole bottom edge 36be extending becoming the part the notched tab 126nt at the hole 36.

FIG. 40 shows the trough 132 is on top of the spacer block 55 with a bracing member shown as U shaped channel 155 facing upward with the bottom side 155d installed at the bottom of the trough 132 and the two parallel sides 155b against both sides of the trough. The first piece of the two piece bracket is a multi-plane bracket shown as a reverse lip bracket 208 having a bottom side 208d with two vertically parallel side 208b with lips 208c extending outwardly. The parallel sides 208b are installed between the parallel sides 155b of the bracing member. The lips 208c of the reverse lip bracket 208 has ½ notches 126n engaging the sides of the hole 36 of the support member shown as a C channel 42 and another ½ notch 126n at each lip 208c and extending into the parallel sides 208b so the second piece of the two piece bracket shown as a flat plate 201 can be inserting into the ½ notch 126. The flat plate 201 is also fastened to the web 42a of the support member and the first piece can be connected to the bottom side 155d of the bracing member if the additional fastener is required for additional strength.

FIG. 41 is an enlargement of the two piece bracket shown with two different types of flat plates 201 and a U shape flat plate 206 with both members having their edges inserted into the notches 126 and fastened to the support member.

FIG. 42 shows an upward oriented U channel 155 having a bottom side 155d and two parallel sides 155b passing through the hole 36 in the web 42a of the support member shown as a C channel 42. In FIG. 42 the two piece bracket consists of a downward facing U shaped bracket 205 having a top side 205a and two parallel sides 205b extending downward and a flat plate 201. The two parallel sides 205b of the downward facing U shaped bracket 205 fit into the side edges of the parallel sides 155b of the bracing member. The flat plate 201 has a length longer than the width of the hole 36 in the support member in FIG. 44 and shows a continuous groove 121 on the top side 205a of the U shaped bracket with the groove 121 extending into the two parallel sides 205b to secure the flat plate 201 having a horizontal edge that fits into the groove 121 and where the flat plate 201 is then connected by fasteners to the web 42a of the support member. In FIG. 41 shows notches cut in the web 205a and flange 205b cut at both sides of the top side 205a and on each of the two parallel sides 205b of the U shaped bracket 205 so the side edges at the bottom edge of the flat plate 201 can fit into the notches 126 and the flat plate 201 is connected by fasteners to the web 42a of the support members. The U shaped bracket 205 also protects any electrical wires should the bracing channel be used as an electrical chase, in fact the continuous U shape bracket could be used as a conduit to protect any mechanical means passing through the wall framing and spacer blocks. The U shaped bracket 205 can be installed in the hole 36 without the U channel 155 engaging the hole bottom edge 36be and the U shaped bracket 205 can be configured like

FIGS. 44A, 44B & 44C are shown diagonally installed in the metal framed wall where six intersecting U shaped spacer braces 302 intersect at the same hole 36 and all the U shaped spacer braces 302 are wider than the hole 36. In order to show the U shaped spacer braces 302 being continuous FIGS. 44A, 44B & 44C show an enlargement of three different holes 36 in the support members as additional U shaped spacer braces 302 intersect at the holes 36 in the support member. The diagonally oriented spacer braces 302 are shown having the dorsal side of the web 302a with its top side facing upward with the two parallel flanges 302b extending ventrally downward along with a horizontally oriented spacer brace 302 having the web 302a on the downside with the two parallel flanges 302b extending ventrally upward. FIG. 44A shows two diagonally oriented spacer braces where the right U shaped spacer brace 302 has the extension 302e and hook finger 127 passes through the hole 36 with the hook finger 127 bent parallel to the web 42a of the support member and the left U shaped spacer brace 302 has the extension 302e and hook finger 127 pass over the right U shaped spacer brace 302 with the right hook finger 127 fastened to the top side of the right U shaped spacer brace 302. FIG. 44B shows the two upward facing horizontally oriented U shaped spacer braces 302 having the dorsal side on both ends of the bottom side of the web 302a of each U shaped spacer brace 302 having notches 126 at the end or notch-web fingers 127n. The notch-web finger 127n passes through the hole 36 and the end of the notches 126 has tabs 126t at the end that give support to the notches 126 when extending past the hole 36. The notch 126 is formed by installing the notch 126 at the side edges of the web 302a leaving the notch 126 having the web 302a on one side and the opposite side having a tab 126t be the remaining end of the notch-web finger 127n. The notch-web finger 127n of the adjacent horizontally oriented U shaped spacer brace 302 is placed over the notch-web finger 127n of the first horizontally oriented spacer brace 302 with its notch 126 and tab 126t engaging the hole 36. Since the horizontally oriented U shaped spacer braces 302 are wider than the hole 36 the edges of the web 42a and two parallel flanges 302b abut the web 42a for the support member as well as the tab 126t at the end of the notches 126. FIG. 44C shows a upward orient bracing member shown as a horizontal bracing channel 155 passing through the hole 36 with the dorsal side of the web 155a as its bottom side with the two parallel flanges 155b extending ventrally upward. A one piece multi-plane brace 301 having the dorsal side of the web 301a and the two parallel flanges 301b placed within the horizontal bracing channel 155 so the dorsal sides of the web 301a and flanges 301b abut the top side or ventral side of the web 155a and flanges 155b leaving the lips 302c extending over the top edge of the flanges 155b so the web 24a can be inserted into the notches 126 in the lip 301c securing the one piece multi-plane brace 301 into place at the hole 36. The upward facing one piece multi-plane brace 301 also has angular oriented notches 126 installed in the lips 301c and the upper side of the two parallel flanges 301b forming continuous notches 126. Diagonally oriented U shaped spacer braces 302 have their web 302a with its dorsal side facing upward on its top side into the diagonally oriented notches 126 and where the opposite end is shown being installed in FIG. 44A. Whether the spacer braces or U shaped or reverse lip shapes, upward facing or downward facing the spacer braces are interchangeable as well as most of the interlocking connections at the hole 36.

FIG. 46 is similar to FIG. 45 except the space brace is a reverse lip spacer brace 301 however they both have a half-circle shape at the bulge 301g. The bulge 301g is shown as a half-circle being vertically oriented having a bulge notch 126bg on the exterior side of the bulge notch 126bg for the hole side edges 36se to fit into. The flanges 301b extend from the bulge notch 126bg to the lips 301c that extend externally at an angle. The hole lip notches 126hp are vertically oriented and inset into the hole side edges 36se for the longitudinal edges of the lips 301c to be inserted into. The reverse lip spacer brace 301 is inserted into the hole 36 at a slight angle allowing the flanges 301b to bend where the bulge notches 126bg slide into the hole side edges 36se and the reverse lip spacer brace 301 is continually pressed downward until the lips 301c engage the both hole side edges 36se.

FIG. 47 shows a reverse lip spacer brace 301 having a web 301a with bulges 301g at each intersection of the flanges 301b with the left side having a horizontal oriented lip 301c and the right side having an angular oriented lip 301c. The left hole side edge 36se at the bottom corner has a web-bulge notch 126wg as shown in FIG. 45 324 for the bulge 301g to fit into and the left lip 301c has a lip notch 126p for the hole side edge 36se to fit into. The right side would typically have the same above described combination of self-locking connections on the opposing side of the reverse lip spacer brace 301. Another combination of self-locking connection is shown on the right side which is the same combination as shown in FIG. 46.

FIGS. 48-50 show a reverse lip spacer brace 301 having a web 301a with bulges 301g on both sides having flanges 301b extending ventrally inward at an angle from the bulges 301g then bending outward forming a lip 301c. In FIG. 48 the reverse lip spacer brace 301 passes through the hole 36 so the bulge notches 126bg intersect the hole side edges 36se and the longitudinal side edges of the lips 301c are inserted into the hole lip notches 126hp forming a self-locking connection with the hole 36. FIG. 49 has the same reverse lip spacer brace 301 along with the bulge notch 126bg at the bulge 301g. The hole lip notch 126hp is shown as a web notch 126w because the hole side edge 36se at the reverse lip spacer brace 301 is recessed rather than shown as a hole lip notch 126hp. The isometric in FIG. 49 has the same profile as FIG. 48.

FIG. 51 is the same FIG. 18 as shown in provisional application U.S. 62/175,191 dated Jun. 12, 2015 but enlarged as attached to this patent application. FIG. 51 show the downward facing bracing member shown as a U shaped channel 155 having a top side 155a and two parallel sides 155b extending downward over the horizontal tongue 55t. A one piece bracket shown as a flat plate 201 fits between the hole 36 of the web 42a of the support member 42. Lip notches 126p are located on each side of the flat plate 201 to engage the side edges of the hole 36 rather than between the lip 42c of the support member 42 as shown in FIG. 2. The flat plate 201 is shown horizontally to the U shaped channel 155 and is connected by fasteners to the top side 155a of the bracing member securing the bracing member, one piece bracket and the support channel together. Hole notches 126h are shown at the first side and second side of the hole 36 and the lip notches 126p are noted as angled notches and offset notches in relation to the opposing lip notch as both items are shown in patent application Ser. No. 15/430781 filed in Feb. 13, 2017 and is part of this application. The flat plate 201 lip notches 126p can be adjusted and fasten at an angle to obtain the strongest resistance at the lip notches 129p.

FIG. 52 is the same FIG. 20 as shown in provisional application U.S. 62/175,191 dated Jun. 12, 2015 but enlarged as attached to this patent application FIG. 52 show the bracing member as a U shaped channel 155 facing downward over the horizontal tongue 55t of the spacer block 55 leaving the top side 155a to attach to a one piece multi-plane bracket shown as an L-shaped bracket 203. One side 203a of the L-shaped bracket 203 is connected to the top side 155a of the bracing member and connected by a ½ notch 126n that engages the interior surface of lip 42c of the support member shown as a C channel 42. The other side 203b of the L-shaped bracket 203 is longer than the width between the lips 42c and is located on the exterior surface or the lips 42c to form the other side of the ½ notch 126n. In addition side 203a is longer so the length extends past the lips 42c of the support member and has a width larger than the distance between the lips 42c so notches can be formed on both sides to engage the side edges of the lips 42c of the C channel 42. In FIG. 52 the L-shaped bracket 203 shows the intersection of the side 203a and side 203b in the enlarged area shown as C-11. Even though both FIG. 52 appear to look the same and are referred to C-11. The wider width of the horizontally oriented side 203a is reduced to pass through the hole 36 forms ½ notch 126n. The vertically oriented side 203b does not need to be long, just long enough to support a flat plate 201 that fits vertically between the vertically oriented side 203b and the outer surface of the web 42a of the support channel shown as a C channel 42. The other ½ notch 126n is formed when the flat plate 201 is installed vertically and fits against the vertically oriented side 203b and the web 42a.

FIG. 53 shows is the same FIG. 246 as shown in provisional application U.S. 62/298,762 dated Feb. 23, 2015 and shown as FIG. 27 in application U.S. Ser. No. 15/430,781 filed Feb. 13, 2017 as attached to this patent application. FIG. 53 shows an isometric view of a reverse lip spacer brace 301 being terminated at the end of the hole 36 where the web 301a is extended to form a hook finger 127 that extends downward over the hole bottom edge 36be and the two lips 301c are show with lip notches 126p on the near side and the flanges 301b being wrapped around the far side of the hole side edges 36se. The near side of the lip notch 126p and the flap 76 will prevent the reverse lip spacer brace 301 from moving horizontally. The hook finger 127 and lip notch 126p prevent the reverse lip from moving horizontally. The whole notch 126h that support the lip notch 126p prevents the reverse lip spacer brace from moving vertically. Another alternative is the ledge shaft 79s (not shown), but described in FIG's 22 & 23 that could fit above the lip 301c to secure the reverse lip spacer brace 301 at the lip and the hole bottom edge 36be secured the web 301a. In previous pending applications a ledge 79 (not shown) extends from the hole bottom edge 36be and the hook finger 127 can wrap around the ledge 79 to also secure the reverse lip spacer brace 301 from moving vertically.

FIG. 54 is the same FIG. 46 as shown in provisional application US 62/175,191 dated Jun. 12, 2015 as attached to this patent application. FIG. 54 shows a smaller reverse lip bracket fitting into a smaller U bridging channel installed in the key hole of the aperture in a support member. FIG. 46 shows the same bracing member and one piece multi-plane bracket connecting to the hole 36 in the support member as shown in FIG. 22 however the reverse lip bracket 208 and bracing member are smaller in width. FIG. 46 shows a hole 36 that is wider in middle with smaller size holes 36s at the top and bottom edges of the hole 36 which is a standard size hole produced by metal stud manufactures. The reverse lip bracket 208 is installed in the smaller width portion of the hole 36 so the bottom side 208d and the parallel sides 208b fit within the smaller area of the hole 36. The lips 208c with its notches 126 at the ends, are installed so the notches 126 extend on both sides of the throat 36t of the hole 36. The reverse lip channels 156 shown in FIGS. 11 & 17 can also be smaller in width to fit into the smaller size holes 36s.

FIGS. 13 & 14 shows FIGS. 55 & 56 is the same FIGS. 111 & 112 as shown in provisional application U.S. 62/175,191 dated Jun. 12, 2015 and shown as FIGS. 13 & 14 in application U.S. Ser. No. 15/090,460 filed Apr. 4, 2016 as attached to this patent application. FIG. 55 is an add-on connectors 313 where I, C, J, W or hold-down spacer braces have been cut or altered so a hook receiver 129 can be added to the spacer brace in order to continue the spacer braces with a tandem connection. In FIG. 13 the add-on connector 313 has a U-shape with a web 313a and flanges 313b that fit into the ventral side of a U-shape spacer brace 302 with is web 302a and flanges 302b fit tight against the dorsal side of the add-on connector 313. FIG. 55 shows the web 313a and flange 313b protruding from the U-shape spacer brace 302. The add-on connector 313 has an indentation 313i at the web 313a and flanges 313b with the flanges 313b abutting against the web 42a of the support member. The web 313a has a web extension 313we that fits over the web 42a of the support member at the anchor space 355 where the first leg 129a of the hook receiver 129 extends downward against the opposing side of the web 42a then extending horizontally outward from the web 42a forming the second leg 129b with the third leg 129c extending upward leaving a gap 45 between the first leg 129a and the third leg 129c. In FIG. 56 the web 313a of the add-on connector 313 is installed directly over the web 302a of the U shaped spacer brace 302 so the web 302a, flanges 302b and the indentation 313i abut the web 42a of the support member and the web extension 313we rest upon the anchor space 355 with the first leg 129a extending over the support member.

FIG. 57 is the same FIG. 164 as shown in provisional application U.S. 62/242,705 dated Nov. 16, 2015 and shown as FIG. 17 in application U.S. Ser. No. 15/295,172 issued Oct. 17, 2016 as attached to this patent application. FIG. 57 is an isometric view where the U-shaped clip 308 fits over the top edge of two C channel 42 where the web 42a has a ledge 79 bent at the top edge of the web 42a. The ledge 79 is shown wider than the U-shaped clip 308 so the web 308a is inserted into the ledge gap 45g which will allow the dorsal side of the U-shaped clip 308 to be level with the top edge of the support member shown as a C channel 42. Since the U-shaped clip 308 is spanning over two C channel both having the ledge 79 in the web 42a, the rear C channel 42 has a hook finger 127 extend over the web 42a of the rear C channel 42. A punched out tab 326 is shown in the web 308a where the pivot edge 326pe is in the middle between the two C channel 42 and the vented edge 326ve is near the ledge 79 so the tab 326t can extend under the ledge 79. The opposite end shows a hook receiver 129 extend over the closest C channel 42 where the first leg 129a extends over the ventral side of the web 42a of the C channel 42 and the punched out tab 326 has the vented edge 326ve near to ledge 79, so again the tab 326t can extend under the ledge 79. The hook receiver 129 as previously described is engaged to the ventral side of the web 42a of the C channel 42.

The present invention of the unique spacer braces are so versatile that the spacer brace allows for a much easier and quicker installation of metal framing walls, installing horizontal and diagonal lateral bracing or installing hold-down spacer bracing at floors, installing horizontal and diagonal braces between support members either between holes or at the flanges.

It is understood that the invention is not to be limited to the exact details of operation or structures shown and describing in the specification and drawings, since obvious modifications and equivalents will be readily apparent to those skilled in the art. The flexibility of the described invention is very versatile and can be used in many different types of building applications.

1-20. (canceled)

21. A building connection comprising:
a first metal framing member being a support member having a central web with a first planar side and a second planar side, a first side flange and a second side flange and lips extending the flanges inward toward the central web with the central web having an aperture with a first perimeter side and a second perimeter side opposite the first perimeter side penetrating said central web;
a substantially horizontal U-shaped channel-bridging member passing through the aperture in the central web of the first metal framing member having a longitudinal web with longitudinal flanges attached to the longitudinal web at the longitudinal side edges forming a U-shaped channel configuration and fastened to a bridging web connector comprising;
a bridging web connector with a first side bridging edge and a second side bridging edge and a longitudinal length having a first end and a second end sufficient to extend through the aperture and over the longitudinal web of said horizontal U-shaped channel-bridging member with at least one fastener hole between said first end and said aperture and said second end and said aperture, having a width greater than the width of said aperture with a first bridge notch indented from the distal first side bridging edge and a second bridge notch indented from the distal second side bridging edge with said bridge edge notches having a first notch side edge and a second notch side edge with an open notch front end and a closed notch back end with said bridge edge notches being angled from said longitudinal web and offset between said first bridge notch and said second bridge notch to engage the first perimeter side and the second perimeter side of said aperture.

22. The building connection according to claim 21 wherein said bridging web connector with said first bridge notch and said second bridge have congruent tapered angles at said first notch side edge and said second notch side edge.

23. The building connection according to claim 21 wherein the bridging web connector can be skewed at a slight angle in relation to the longitudinal direction of said horizontal U-shaped channel-bridging member allowing said first notch side edge to snuggle tight against the second notch side edge at the first bridging notch and said second bridging notch.

24. The building construction according to claim 22 wherein the bridging web connector being wider than said aperture with the first end and the second end separated by said aperture with said first end having a first width web and at the second end having a wider width web than said first width web forming a deep edge notch at said first bridge notch and said second bridge notch.

25. The building construction according to claim 21 wherein the bridging web connector is semi-rigid configured to the aperture configuration of said first framing member having a curvilinear, multi-plane configuration with said first bridging notch and second bridging notch able to engage said first perimeter side and said second perimeter side against said aperture at the distal edges of said configuration.

26. The building construction according to claim 25 wherein the length of said bridging web connector is greater than the width of said flanges of said first metal framing member with the width at said first end is greater than said aperture and a greater width than said web of said first metal framing member for said first end and said first and said second bridging notches engage said aperture with the second end of said bridging web have a third bridging notch and a fourth bridging notch indent from said first side edge and said second side edge and setback from said second end to engage said lips of said bridging web.

27. The building construction according to claim 26 wherein said bridging web connector has said first bridging notch and said second bridging notch engaging said aperture has a first notch side being part of said bridging web extending over said web of said U-shaped channel-bridging member and said second side notch edge being part of said bridging web bent parallel to the web of said support member forming an L-shaped bridging web connector that extends past said aperture for connecting fastening holes above or below said aperture.

28. The building construction according to claim 21 wherein said bridging web connector has a bridging web with a first bridging edge connected to a first bridging flange and said second bridging edge connected with a second bridging flange extending at an angle away from said bridging web with a third bridging flange extending outward from said first bridging flange and a fourth bridging flange extending outward from said second bridging flange with said third bridging flange and said fourth bridging flange having at least one said bridging notch setback from said first end and said second end and indented from the distal edge of said third bridging flange and said fourth bridging flange to engage said first perimeter side edges and said second perimeter side edges of said aperture in said first metal framing member forming a bridging bracket connector with fastener holes at said bridging web separated by said first metal framing member.

29. The building construction according to claim 28 wherein said bridging bracket connector between said first end and said aperture has a wide width at said third bridge flange and said fourth bridge flange with a smaller width at the opposing side of said aperture at said third bridge flange and said fourth bridge flange.

30. The building construction according to claim 28 wherein said bridging bracket connector has said bridging web with fastening holes setback from said first end and said second end and said bridging web said first bridging flange and said second bridging flange snuggly fitting between said first longitudinal flange and said second longitudinal flange of said horizontal U-shaped channel-bridging member and said third bridging flange with said bridging notch and said fourth bridging flange with said bridging notch extending away from said first and said second longitudinal flanges to engage said perimeter side edges of said aperture and fasteners engaging said web of U-shaped channel with said U-shaped channel bridging member.

31. The building construction according to claim 30 wherein said bridging bracket connector extends between said first metal framing member at said first end and a second metal framing member substantially similar to said first metal framing member at said second end for said third bridging flange and said fourth bridging flange have said flange bridging notches indented into the distal edge of said third bridging flange and said fourth bridging flange and setback from said first end and said second end to engage said apertures of said first metal framing member and said second metal framing member.

32. The building construction according to claim 21 wherein the aperture in the central web of said first framing member can have an irregular shape, multi-plane shape, circular shape and curvilinear shape aperture configuration at said perimeter with said perimeter notches indented into said first perimeter side and said second perimeter side with perimeter notches having an open notch end, a back notch end with said first side notch edge above said second side notch edge for said back notch edge in said first and second bridge notches in said bridging web or in said back notch edge in said third and fourth flanges.

33. The building construction according to claim 30 wherein said bridging bracket connector having said third bridging flange with said bridging notch and said fourth bridging flange with said bridging notch with said bridging notches having a wide width opening for said bridging notches to engage said aperture of said first framing member and a flat plat extending into said bridging notches fastened to said web at both sides of said aperture and connected to said U-shaped channel bridging member.

34. The building construction according to claim 28 wherein said bridging notches can have at least one flare edge and wherein the third and fourth bridging flanges can have a greater width at said first end than said second end.

35. The building construction according to claim 33 wherein said third bridging flange and said fourth bridging flange have bridging flange notches to connect additional bridging connectors to attached to said support members.

36. The building construction according to claim 29 wherein said bridging bracket connector has a continuous bridging notches at said web and indented into said side wall flanges for additional bridging connector to attached to said support members.

37. The building construction according to claim 27 wherein said L-shaped bridging web connector has indented bridging notches at both side edges of the bent web at said first side bridging edge and said second side bridging edge to engage said perimeter side edge or said perimeter bottom edge of said aperture of said support member with said bridging notches being angular or offset to the opposing bridging notches at said first side bridging edge or said second side bridging edge.

27. The building construction according to claim 26 wherein said bridging web connector has said first bridging notch and said second bridging notch engaging said aperture has a first notch side being part of said bridging web extending over said web of said U-shaped channel-bridging member and said second side notch edge being part of said bridging web bent parallel to the web of said support member forming an L-shaped bridging web connector that extends past said aperture for connecting fastening holes above or below said aperture.
